(19) United States
(12) Patent Application Publication
(10) Pub. No.: US 2025/0264739 A1
(43) Pub. Date: Aug. 21, 2025

(54) PHOTONIC DEVICES WITH POLARIZATION-BASED WAVELENGTH COMBINING

(71) Applicant: Intel Corporation, Santa Clara, CA (US)

(72) Inventors: Saeed Fathololoumi, Los Gatos, CA (US); Ling Liao, Santa Clara, CA (US); Christian Malouin, San Jose, CA (US)

(73) Assignee: Intel Corporation, Santa Clara, CA (US)

(21) Appl. No.: 18/444,411

(22) Filed: Feb. 16, 2024

(51) Int. Cl. G02F 1/01; G02B 6/27; G02B 6/293

(52) U.S. Cl. CPC G02F 1/0136; G02B 6/2773; G02B 6/2938

(57) ABSTRACT

Photonic devices, packages, and systems are disclosed. An example photonic device includes a first optical waveguide to support propagation of a first multi-wavelength optical signal, a second optical waveguide to support propagation of a second multi-wavelength optical signal, a third optical waveguide to support propagation of a third multi-wavelength optical signal, and a combiner configured to receive the first multi-wavelength optical signal from the first optical waveguide, receive the second multi-wavelength optical signal from the second optical waveguide, and provide to the third optical waveguide the third multi-wavelength optical signal, wherein the third multi-wavelength optical signal is a combination of the first multi-wavelength optical signal having a first polarization and the second multi-wavelength optical signal having a second polarization, different from the first polarization.

### BACKGROUND

Optical interconnects are increasingly being employed in various applications, including telecommunications, data centers, and computer systems, to establish communication links between different elements or devices within a given system. In contrast to traditional electrical interconnects, which rely on copper cables to transmit electrical signals, optical interconnects use electromagnetic signals with wavelengths in the optical and microwave portions of the electromagnetic spectrum (such signals referred to in the following as “optical signals” or “light signals” or, simply, as “light”), typically in the form of laser beams, to transmit data over optical waveguides. Optical interconnects may have various advantages over electrical interconnects, such as higher bandwidth, low latency, reduced electromagnetic interference, and energy efficiency. Therefore, photonic devices, packages, and systems that enable implementation of optical interconnects are of great importance.

### BRIEF DESCRIPTION OF THE DRAWINGS

Embodiments will be readily understood by the following detailed description in conjunction with the accompanying drawings.

FIG. 1 is a schematic illustration of one example of a photonic device with polarization-based wavelength combining, according to an embodiment.

FIGS. 2A-2B illustrate wavelength distribution across two busses as shown in FIG. 1, according to an embodiment.

FIG. 3 is a schematic illustration of another example of a photonic device with polarization-based wavelength combining, according to an embodiment.

FIGS. 4A-4B illustrate wavelength distribution across two busses as shown in FIG. 3, according to an embodiment.

FIG. 5 is a schematic illustration of yet another photonic device with polarization-based wavelength combining, according to an embodiment.

FIGS. 6A-6C are schematic illustrations of further photonic devices with polarization-based wavelength combining, according to various embodiments.

FIG. 7 is a top view of a wafer and dies that may be included in a photonic device with polarization-based wavelength combining, according to an embodiment.

FIG. 8 is a side, cross-sectional view of an example microelectronic package that may include a photonic device with polarization-based wavelength combining, according to an embodiment.

FIG. 9 is a block diagram of an example photonic device that may include polarization-based wavelength combining, according to an embodiment.

### DETAILED DESCRIPTION

Photonic devices, packages, and systems are disclosed. An example photonic device includes a first optical waveguide to support propagation of a first multi-wavelength optical signal, a second optical waveguide to support propagation of a second multi-wavelength optical signal, a third optical waveguide to support propagation of a third multi-wavelength optical signal, and a combiner configured to receive the first multi-wavelength optical signal from the first optical waveguide, receive the second multi-wavelength optical signal from the second optical waveguide, and provide to the third optical waveguide the third multi-wavelength optical signal, wherein the third multi-wavelength optical signal is a combination of the first multi-wavelength optical signal having a first polarization and the second multi-wavelength optical signal having a second polarization, different from the first polarization.

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating photonic devices with polarization-based wavelength combining described herein, it might be useful to first understand phenomena that may come into play in some systems where wavelength combining may be used. The following foundational information may be viewed as a basis from which the present disclosure may be properly explained. Such information is offered for purposes of explanation only and, accordingly, should not be construed in any way to limit the broad scope of the present disclosure and its potential applications.

Over the last 5 decades, computation power has been scaling per Moore's law by advancements in complementary metal-oxide-semiconductor (CMOS) technology nodes. Until the early 2000s computation power scaled with faster processor clock rate. Over the past 20 years computation power has scaled by the addition of more cores and compute resources so workloads can be shared among them. Recent high-performance computing (HPC) and artificial intelligence (AI) workloads have made it necessary to scale computation power beyond the board level. Efficiently and scale of these new systems rely on bandwidth, reach, latency, and power efficiency of interconnects. With electrical input/output (I/O) interconnects facing challenges in terms of scalability along all these vectors, there is a need for a new interconnect technology to complement copper. Hence, optical interconnects are being considered across industry to achieve low power, long reach, and high bandwidth density I/O links between dies.

Optical interconnects often utilize wavelength division multiplexing (WDM), also referred to as “wavelength combining,” to increase the data transmission capacity over a single optical medium such as an optical fiber. Wavelength combining involves sending multiple optical signals, each at a different wavelength, simultaneously over the same optical fiber. This allows for the parallel transmission of several independent data streams, effectively increasing the overall bandwidth of the communication link.

Current state of the art is to combine optical signals of 8 wavelengths at 32 gigabits per second (Gbps) data rate, and, for future applications, more bandwidth density is required from optical interconnects. Hence, for the next generation of optical interconnects greater numbers of wavelengths and higher data rates are needed. However, scaling photonic devices to support greater numbers of wavelengths and higher data rates for optical interconnects that use wavelength combining is a challenging task, and various factors can impact the cost, quality, and robustness of these photonic devices. Physical limitations, including constraints on space or surface area, along with considerations of power consumption, can impose additional restrictions on photonic devices incorporating wavelength combining.

Disclosed herein are photonic devices, packages, and systems that aim to improve on one or more challenges described above. Embodiments of the present disclosure are based on recognition that, when wavelength combining is used to embed data into optical signals of N distinct wavelengths, a set of N wavelengths may be split into a first subset and a second subset, transmitted and modulated on two different busses, and combined, after modulation, into a single output signal with polarization of the optical signals of one of the subsets being changed to a polarization that is substantially orthogonal to that of the optical signals of the other one of the subsets. For example, a first multi-wavelength optical signal comprising a combination of the optical signals of the first subset may be sent over the first bus to have data modulated onto the first subset of wavelengths. A second multi-wavelength optical signal comprising a combination of the optical signals of the second subset may be sent over the second bus to have data modulated onto the second subset of wavelengths. After modulation, polarization of one of the first and second optical signals may be changed to being substantially orthogonal to that of the other one, and, after the change in polarization, the two signals may be combined and sent over a single output bus. Such an approach may be referred to as “polarization-based wavelength combining.” By implementing polarization-based wavelength combining as described herein, a compact photonic integrated circuit (PIC) for 16 wavelength optical link at 64 Gbps data rate may be realized, and even larger number of wavelengths and higher data rates may be feasible.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

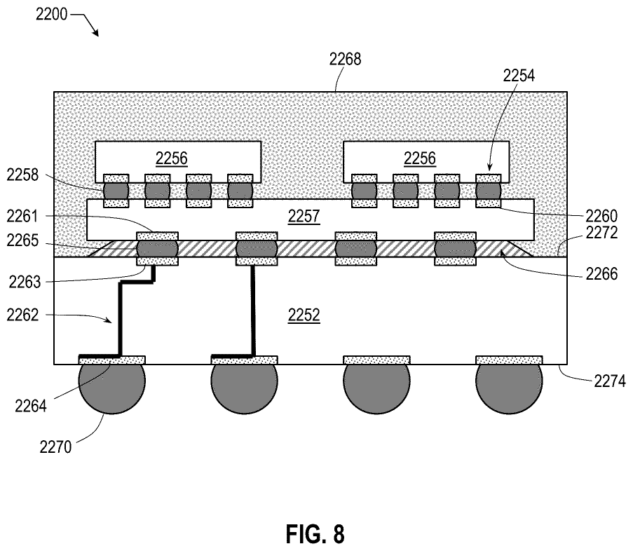

Any of the features discussed with reference to any of accompanying drawings herein may be combined with any other features to form a photonic device 100, a microelectronic package 2200, or a computing device 2400, as appropriate. For convenience, the phrase “lasers 112” may be used to refer to a collection of lasers 112-1, 112-2, and so on, while the phrase “laser 112” may be used to refer to one of the lasers 112, and analogous applies to other reference numerals that may be used in combination with a number after a dash. Similarly, the phrase “modulators T” may be used to refer to a collection of modulators T1, T2, and so on, while the phrase “modulator T” may be used to refer to one of the modulators T, and analogous applies to other reference letters that may be used in combination with a number. A number of elements of the drawings with same reference numerals may be shared between different drawings; for ease of discussion, a description of these elements provided with respect to one of the drawings is not repeated for the other drawings, and these elements may take the form of any of the embodiments disclosed herein. The drawings are not necessarily to scale. Although some of the drawings (e.g., FIG. 8) illustrate rectilinear structures with flat walls/surfaces and right-angle corners, this is simply for ease of illustration and may not reflect real-life process limitations which may cause various features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias, trenches, or other openings, inadvertent rounding of corners or variations in thicknesses of different material layers. There may be other defects not listed here but that are common within the field of semiconductor device fabrication and packaging. Inspection of layout and mask data and reverse engineering of parts of a device to reconstruct the circuit using e.g., optical microscopy, TEM, or SEM, and/or inspection of a cross-section of a device to detect the shape and the location of various device elements described herein using, e.g., Physical Failure Analysis (PFA) would allow determination of presence of photonic devices with polarization-based wavelength combining as described herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10%, e.g., within +/−5% or within +/−2%, of the exact orientation.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. As used herein, the terms “package” and “IC package” are synonymous, as are the terms “die” and “IC die.” Furthermore, the terms “chip,” “chiplet,” “die,” and “IC die” may be used interchangeably herein. Although certain elements may be referred to in the singular herein, such elements may include multiple sub-elements. For example, “an optical amplifier” may include one or more optical amplifiers or “a multiplexer” may include one or more multiplexers.

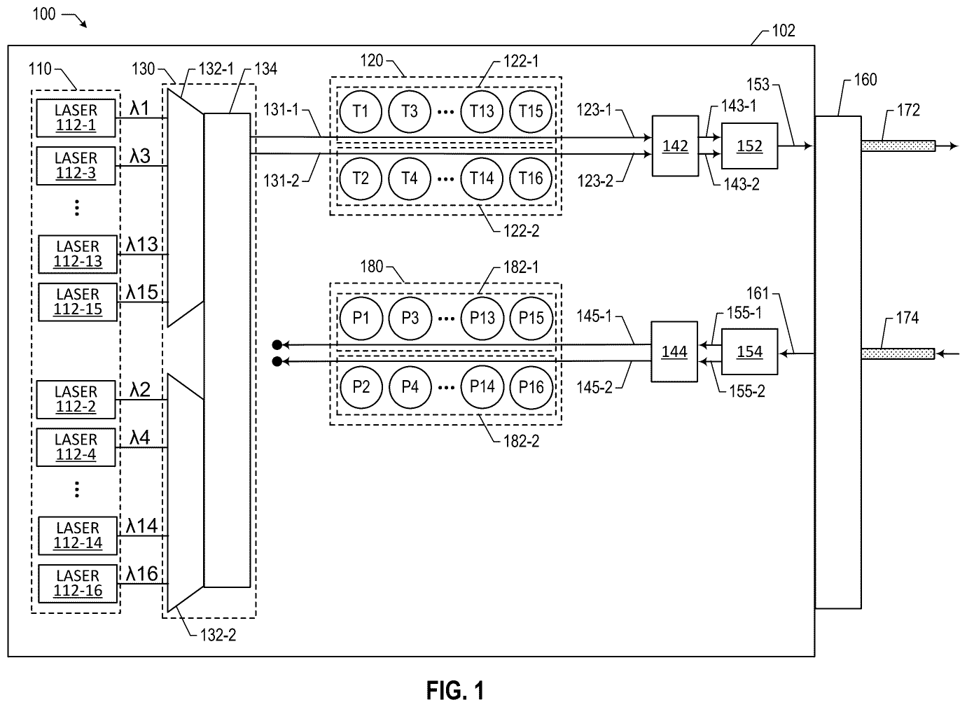

FIG. 1 is a schematic illustration of one example of a photonic device 100 with polarization-based wavelength combining, according to an embodiment. As shown in FIG. 1, the photonic device 100 may include a support 102, a laser array 110 comprising a plurality of lasers 112, an optical connector 160, a detector array 180, a transmit (TX) path between the laser array 110 and the optical connector 160, and a receive (RX) path between the optical connector 160 and the detector array 180. As also shown in FIG. 1, the photonic device 100 may further include a TX fiber 172 and a RX fiber 174 that may be plugged into the optical connector 160. A TX path may be a path of the optical signals propagating from the laser array 110 to the TX fiber 172, to carry data, embedded in optical signals, from the photonic device 100 to another device such as another photonic device, a chip, or a die. A RX path may be a path of the optical signals propagating from the RX fiber 174 to the detector array 180 to carry data, embedded in optical signals, from another device such as another photonic device, a chip, or a die, to the photonic device 100. FIG. 1 illustrates that the TX path may include a multiplexer 130, a modulator array 120, a TX optical amplifier 142, and a combiner 152, while the RX path may include a splitter 154, an RX optical amplifier 144, and the detector array 180. FIG. 1 and other drawings illustrate various optical signals propagating over the TX path and the RX path as arrows, with reference numerals and symbols given to individual signals. It is to be understood that these arrows also represent the optical media (e.g., waveguides) over which the optical signals are propagating in the photonic device 100, and that each arrow may represent an “optical bus” (which may be referred to, simply, as a “bus”).

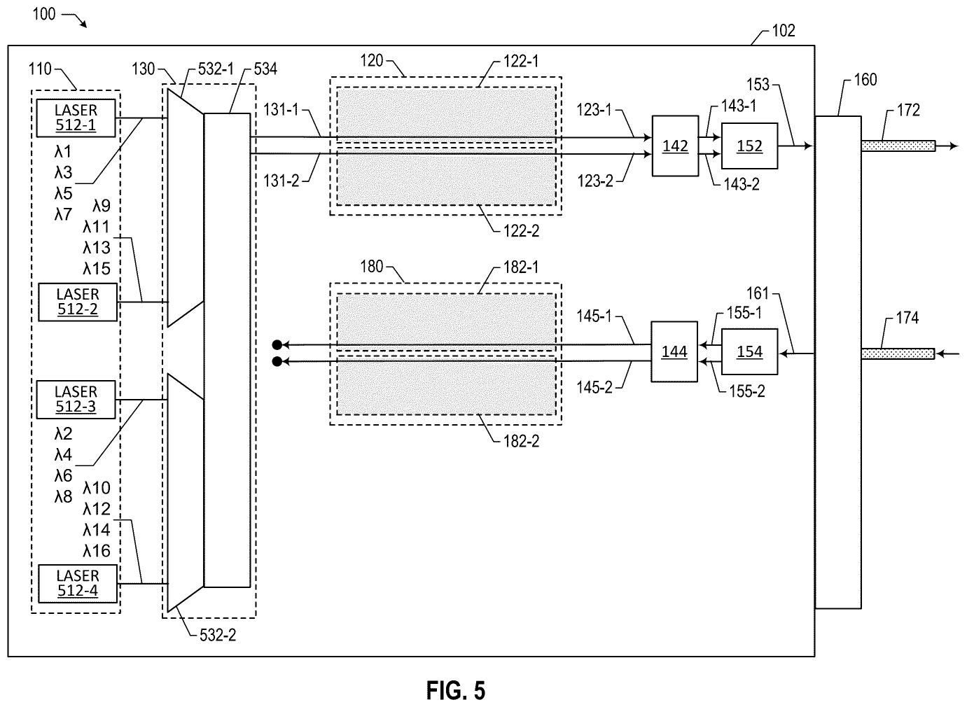

The laser array 110 may include N lasers 112, where N is an integer greater than 1. The lasers 112 are individually shown in FIG. 1 as a laser 112-1, a laser 112-2, a laser 112-3, and so on until a laser 112-16. Thus, for the example of FIG. 1, N is equal to 16. However, while FIG. 1 and laser arrays 110 shown in subsequent drawings illustrate a certain number of lasers 112 (e.g., sixteen lasers 112 are illustrated in FIG. 1, four lasers 512 are illustrated in FIG. 5, etc.), in various embodiments, a laser array 110 and/or a photonic device 100 may include any number N of two or more lasers 112. In the embodiment shown in FIG. 1, each of the lasers 112-i is configured to output light at a certain distinct wavelength λi, where i is an integer between 1 and N that identifies one of the N lasers 112. In such an embodiment, the laser 112-1 may output light of a wavelength λ1, provided as an optical signal λ1 at the output of the laser 112-1; the laser 112-2 may output light of a wavelength λ2, provided as an optical signal λ2 at the output of the laser 112-2; the laser 112-3 may output light of a wavelength λ3, provided as an optical signal λ3 at the output of the laser 112-3; and so on. Thus, more generally, the laser array 110 may output optical signals of N different wavelengths, λ1 to λN, which wavelengths may be arranged in a sequency from the smallest wavelength λ1 to the largest wavelength λN (i.e., the N wavelengths may be arranged in an ascending sequence), or the other way around (i.e., the N wavelengths may be arranged in a descending sequence). In some embodiments, spacing between adjacent wavelengths λ of the outputs of different lasers 112 may be ranging from about 1 angstrom to about 50 nanometers, e.g., from sub-nanometer to about 30 nanometers, or between about 1 nanometer and 20 nanometers. In some embodiments, the wavelengths λ of different lasers 112 may be in the range between about 1100 nanometers and about 1700 nanometers, e.g., about 1300 nanometers or about 1550 nanometers. In context of the present disclosure, an optical signal of a wavelength λi may refer to a limited range of wavelengths with the wavelength λi being the central wavelength of the range. In some embodiments, one or more of the lasers 112 may be implemented as distributed Bragg reflector (DBR) lasers. In some embodiments, one or more of the lasers 112 may be implemented as distributed feedback (DFB) lasers.

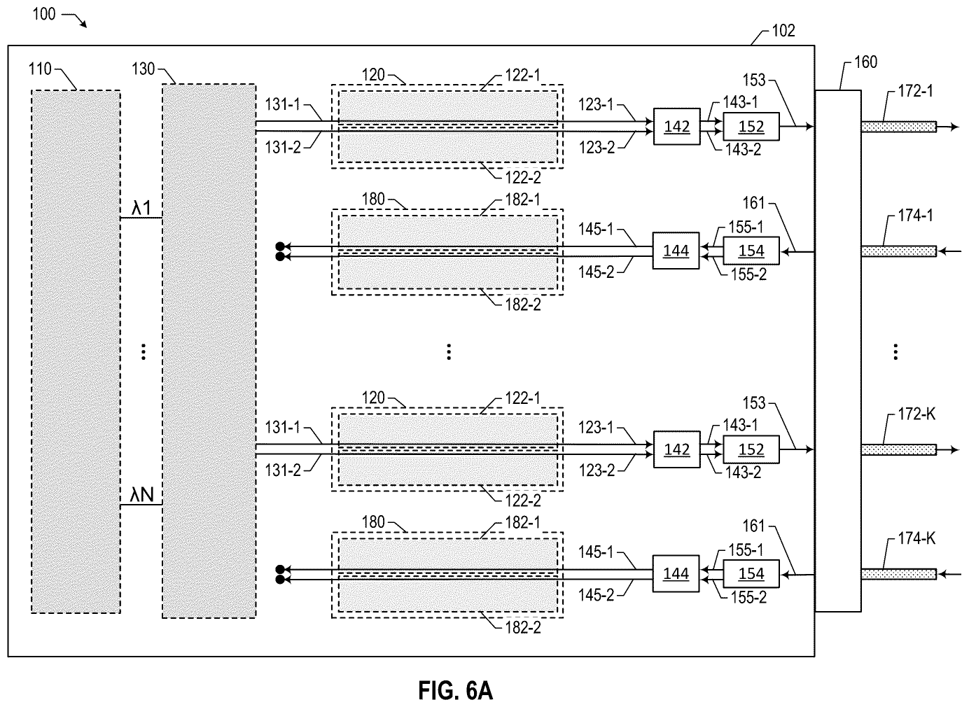

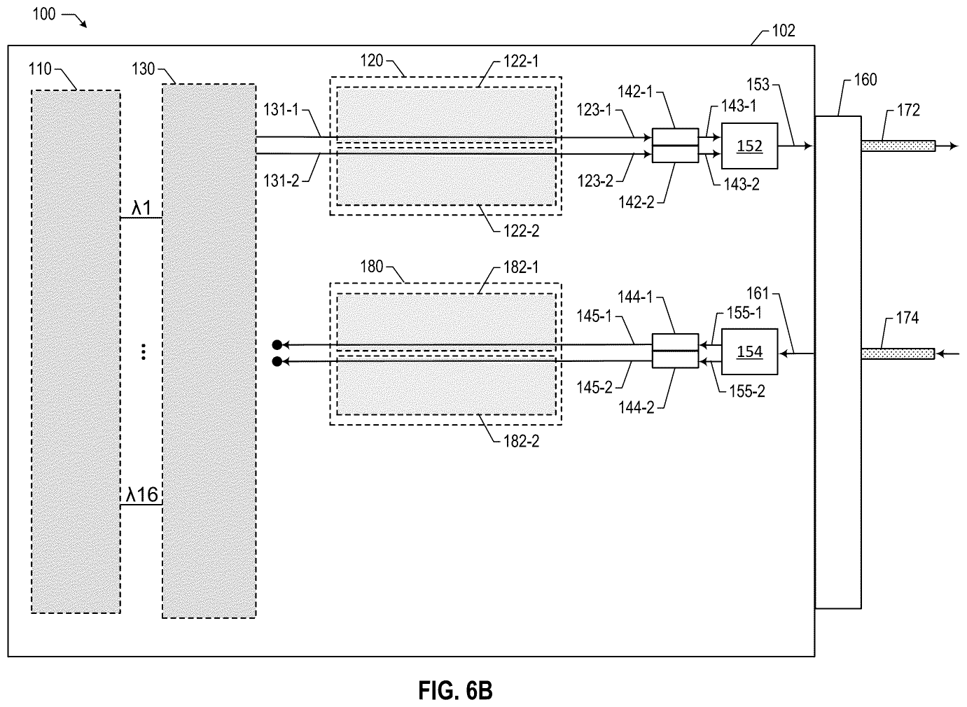

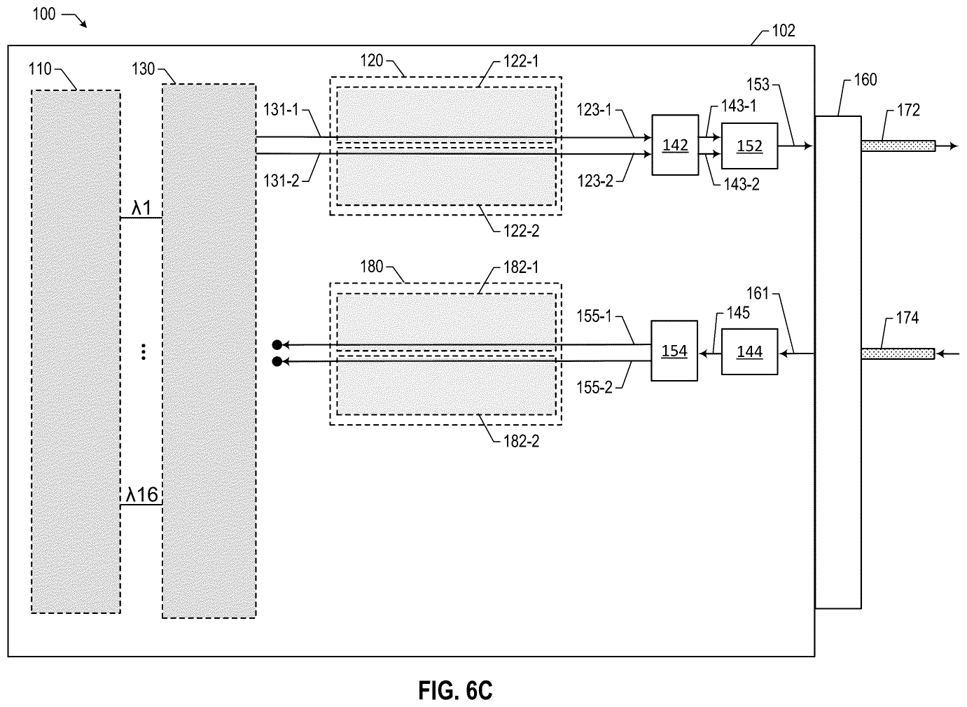

FIG. 1 illustrates that an N×M multiplexer 130 may be arranged between the laser array 110 and the modulator array 120, where N is the number of inputs to the multiplexer 130, M is the number of outputs of the multiplexer 130, and where, similar to N, M is also an integer greater than 1. N inputs to the multiplexer 130 may be based on the N optical signals λ1, λ2, . . . , and λ16 generated by the laser array 110. The multiplexer 130 of the photonic device 100 may be an N×M combiner and splitter. To that end, the multiplexer 130 may be configured to combine the N optical signals of wavelengths λ1 to λN, provided as N inputs to the multiplexer 130, into at least two optical signals 131-1 and 131-2 (together referred to as “optical signals 131”) provided at the output of the multiplexer 130. The multiplexer 130 may then provide optical signals 131 at M outputs of the multiplexer 130. For the example of FIG. 1, M is equal to 2; however, in other embodiments, M be an integer larger than 2, e.g., when the photonic device 100 includes multiple TX paths (e.g., multiple pairs of the optical signals 131-1 and 131-2, as shown in FIG. 6A).

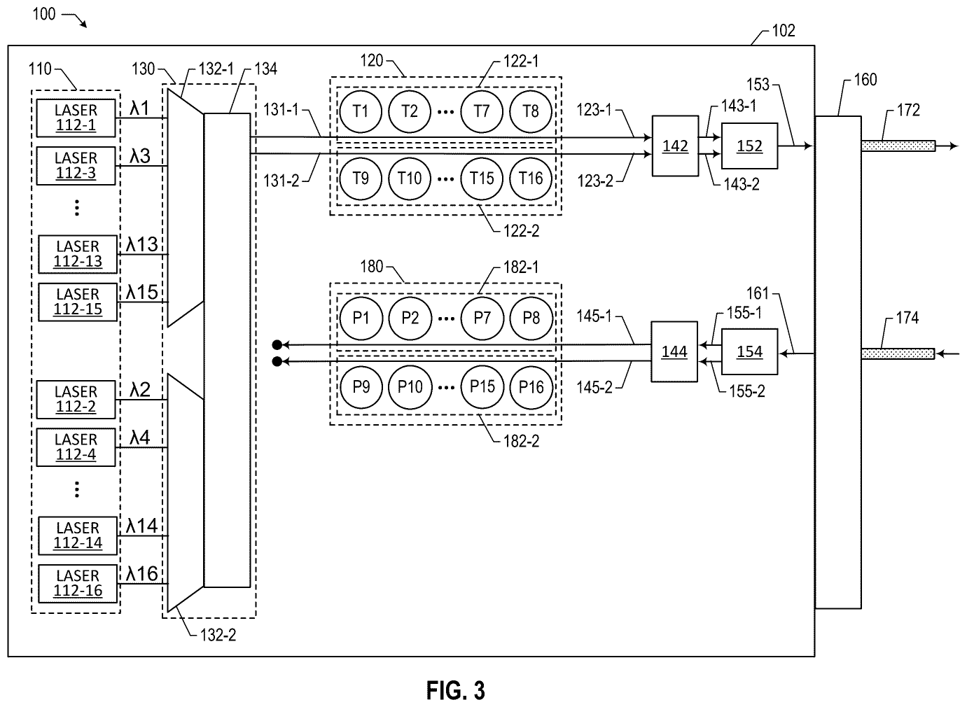

The optical signal 131-1 may include a first subset of wavelengths of the set of wavelengths λ1 to λN, while the optical signal 131-2 may include a second subset of wavelengths of the set of wavelengths λ1 to λN that includes all of the wavelengths of the set λ1 to λN that are not in the first subset. Thus, the first and second subsets are disjoint subsets (i.e., they have no elements in common) and are complementary subsets of the set λ1 to λN (i.e., the elements in one subset are precisely those that are not in the other subset, and vice versa). Example shown in FIG. 1 illustrates that the optical signal 131-1 may be a multi-wavelength signal including a combination of odd wavelengths of the sequence of wavelengths λ1 to λN (e.g., the optical signal 131-1 may be a multi-wavelength signal including wavelengths λ1, λ3, λ5, λ7, λ9, λ11, λ13, and λ15), while the optical signal 131-2 may be a multi-wavelength signal including a combination of even wavelengths of the sequence of wavelengths λ1 to λN (e.g., the optical signal 131-2 may be a multi-wavelength signal including wavelengths λ2, λ4, λ6, λ8, λ10, λ12, λ14, and λ16). However, in other embodiments, the division of wavelengths λ1 to λN into first and second subsets of the optical signals 131-1 and 131-2 may be different, with one other example shown in FIG. 3. In further embodiments of the photonic device 100, the first and second subsets of the optical signals 131-1 and 131-2 may be different from what is shown in FIG. 1 and FIG. 3, where all different manners of splitting the wavelengths λ1 to λN into first and second subsets of the optical signals 131-1 and 131-2 are within the scope of the present disclosure, as long as the first and second subsets are disjoint, complementary subsets of the set of wavelengths λ1 to λN.

Different ways of implementing the multiplexer 130 are known in the art, all of which being within the scope of the present disclosure. For example, in some embodiments, the multiplexer 130 may be, or may include, a Mach-Zehnder Interferometer (MZI). FIG. 1 illustrates that, in some embodiments, the multiplexer 130 may include a WDM multiplexer 132-1 and a WDM multiplexer 132-2, as well as a swizzle network 134. The WDM multiplexer 132-1 may be configured to receive the odd wavelengths of the wavelengths λ1 to λN output by the laser array 110 and combine them into a single first multi-wavelength signal provided to the swizzle network 134. Similarly, the WDM multiplexer 132-2 may be configured to receive the even wavelengths of the wavelengths λ1 to λN output by the laser array 110 and combine them into a single second multi-wavelength signal provided to the swizzle network 134. The swizzle network 134 may then provide optical signals 131-1 and 131-2 that are based on the inputs received from the WDM multiplexers 132-1 and 132-2. In other embodiments of the photonic device, the multiplexer 130 may include any other combination of components to generate the optical signals 131-1 and 131-2 based on the wavelengths λ1 to λN output by the laser array 110, all of which being within the scope of the present disclosure.

In each bus coupled to one of the outputs of the multiplexer 130 (e.g., in a path for each of the optical signals 131), the modulator array 120 may include a corresponding modulator arrangement 122 including at least the number of modulators (each denoted as “T” in FIG. 1) that is equal to the number of wavelengths in the respective optical signal 131 of that bus. Individual modulator arrangements 122 are labeled in FIG. 1 as a modulator arrangement 122-1 in a path of the optical signal 131-1 and a modulator arrangement 122-2 in a path of the optical signal 131-2. The number of modulator arrangements 122 may be equal to the number M of the outputs of the multiplexer 130. Each of the modulators T may be configured to modulate a portion of the optical signal 131 of one of the wavelengths λ1 to λN to embed data into those optical signals. The number of modulators T within a modulator arrangement 122 of a given bus coupled to an output of the multiplexer 130 may be equal to the number of the wavelengths in the respective subset of wavelengths of the optical signal 131 that may propagate over that bus. Thus, as shown in FIG. 1, the modulator arrangement 122-1 includes modulators T corresponding to different odd wavelengths of the wavelengths λ1 to λN (the modulators T individually labeled with a reference numeral following the letter “T” to indicate one of the wavelengths λ1 to λN), i.e., modulators T1, T3, . . . , T13, and T15. Similarly, as shown in FIG. 1, the modulator arrangement 122-2 includes modulators T corresponding to different even wavelengths of the wavelengths λ1 to λN, i.e., modulators T2, T4, . . . , T14, and T16.

For a given optical signal 131, each of the modulators T of the modulator arrangement 122 in the path of that optical signal 131 is configured to modulate a portion corresponding to one of the wavelengths λ1 to λN. For example, for the optical signal 131-1, a modulator T1 of the modulator arrangement 122-1 is configured to modulate a portion corresponding to the wavelength λ1 within the optical signal 131-1, a modulator T3 is configured to modulate a portion corresponding to the wavelength λ3 within the optical signal 131-1, a modulator T5 is configured to modulate a portion corresponding to the wavelength λ5 within the optical signal 131-1, and so on. In some embodiments, there may be a one-to-one correspondence between the number of the wavelengths λ1 to λN and the combination of the modulators T of the modulator arrangements 122-1 and 122-2.

Within a given modulator arrangement 122 of the modulator array 120, the modulators T may apply modulation to the distinct wavelengths of the wavelengths λ1 to λN to generate a modulator output signal that includes a combination (e.g., a superposition) of the signals of different wavelengths λ1-λN. In some embodiments, the modulators T may be wavelength-selective modulators, which means that a given modulator T may receive as an input an optical signal that includes multiple wavelengths, but only apply modulation to a portion of the optical signal for which the carrier wavelength is that of the associated one of the wavelengths λ1 to λN. Multiple modulators T of a given modulator arrangement 122 in the path of that optical signal 131 may be connected in series (e.g. an output of one modulator may be an input to the next modulator). For example, consider an example where the modulators T of the modulator arrangement 122-1 are arranged in the path of the optical signal 131-1 in series in the order shown in FIG. 1. In such an example, the modulator T1 may receive as an input the optical signal 131-1 that is a combination of optical signals corresponding to the odd wavelengths of the wavelengths λ1 to λN, with all wavelengths being unmodulated at that point, and apply modulation to a portion of the optical signal 131-1 corresponding to the wavelength λ1 to generate a modulated portion of the optical signal 131-1 corresponding to the wavelength λ1. The modulator T1 may further be configured to pass portions of the optical signal 131-1 corresponding to the wavelengths λ3, λ5, λ7, λ9, λ11, λ12, and λ15 further without modulation. Thus, an output of the modulator T1 may be a combination of a modulated portion of the optical signal 131-1 corresponding to the wavelength λ1 and unmodulated portions of the optical signal 131-1 corresponding to the wavelengths λ3, λ5, λ7, λ9, λ11, λ12, and λ15. After that, the modulator T3 of the modulator arrangement 122-1 may receive as an input the output generated by the modulator T1, and apply modulation to a portion of the optical signal 131-1 corresponding to the wavelength λ3 to generate a modulated portion of the optical signal 131-1 corresponding to the wavelength λ3. The modulator T3 may further be configured to pass portions of the optical signal 131-1 corresponding to the wavelengths λ5, λ7, λ9, λ11, 12, and λ15 without modulation, as well as pass without modulation the modulated portion of the optical signal 131-1 corresponding to the wavelength λ1 that was generated by the modulator T1. Thus, an output of the modulator T3 may be a combination of a modulated portion of the optical signal 131-1 corresponding to the wavelength λ1, a modulated portion of the optical signal 131-1 corresponding to the wavelength λ3, and unmodulated portions of the optical signal 131-1 corresponding to the wavelengths λ5, λ7, λ9, λ11, λ12, and λ15. Next, the modulator T5 of the modulator arrangement 122-1 may receive as an input the output from the modulator T3, and apply modulation to a portion of the optical signal 131-1 corresponding to the wavelength λ5 to generate a modulated portion of the optical signal 131-1 corresponding to the wavelength λ5. The modulator T5 may further be configured to pass portions of the optical signal 131-1 corresponding to the wavelengths λ7, λ9, λ11, λ12, and λ15 without modulation, as well as pass without modulation the modulated portion of the optical signal 131-1 corresponding to the wavelength λ1 that was generated by the modulator T1 and the modulated portion of the optical signal 131-1 corresponding to the wavelength λ3 that was generated by the modulator T3. Thus, an output of the modulator T5 may be a combination of a modulated portion of the optical signal 131-1 corresponding to the wavelength λ1, a modulated portion of the optical signal 131-1 corresponding to the wavelength λ3, a modulated portion of the optical signal 131-1 corresponding to the wavelength λ5, and unmodulated portions of the optical signal 131-1 corresponding to the wavelengths λ7, λ9, λ11, λ12, and λ15. This may continue until all of the modulators of the modulator arrangement 122-1 have applied modulation to portions of the optical signal 131-1 corresponding to one of their respective wavelengths, so that a modulator output signal 123-1 provided at the output of the modulator arrangement 122-1 is an optical signal including modulated portions of the wavelengths λ1 to λN that were included in the optical signal 131-1. Analogous applies to other busses coupled to other outputs of the multiplexer 130, e.g., a modulator output signal 123-2 may be provided at the output of the modulator arrangement 122-2, and may be an optical signal including modulated portions of the wavelengths λ1 to λN that were included in the optical signal 131-2. For the example of FIG. 1, the modulator output signal 123-1 is a multi-wavelength signal that includes a combination of modulated portions of the wavelengths λ1, λ3, λ5, λ7, λ9, λ11, λ12, and λ15 that were included in the optical signal 131-1, while the modulator output signal 123-2 is a multi-wavelength signal that includes a combination of modulated portions of the wavelengths λ2, λ4, λ6, λ8, λ10, λ12, λ14, and λ16 that were included in the optical signal 131-2.

Different ways of implementing modulators T are known in the art, all of which being within the scope of the present disclosure. For example, in some embodiments, modulators T of the modulator array 120 may be implemented as ring modulators, e.g., as wavelength-selective ring modulators. Various types of optical modulators may be used as the modulators T of the modulator array 120 to modulate data onto optical signals 131. The choice of the type of the modulators T may depend on the specific requirements of the system, including the modulation format, data rate, and the nature of the transmitted signals.

The modulator output signals 123-1 and 123-2 may be provided to the TX optical amplifier 142, which may amplify these signals and provide respective amplified outputs as an TX amplifier output signal 143-1 and an TX amplifier output signal 143-1, respectively. While FIG. 1 illustrates a single TX optical amplifier 142 in the path of both of the modulator output signals 123, in other embodiments, the photonic device 100 may include a respective TX optical amplifier 142 for each of the modulator output signals 123-1 and 123-2, e.g., as shown in FIG. 6B. In other embodiments of the photonic device 100, the TX optical amplifier 142 may be omitted, and the modulator output signals 123-1 and 123-2 may be provided directly to the combiner 152.

Modulated optical signals of the TX path of the photonic device 100 may then be provided to the combiner 152. The outputs of the lasers 112 may be optical signals having the same polarization, e.g., the same substantially linear polarization, such as all of the wavelengths λ1 to λN may be horizontally polarized optical signals. As the optical signals of wavelengths λ1 to λN traverse the multiplexer 130, the waveguides supporting propagation of the optical signals 131, the modulator array 120, and the TX optical amplifier 142, polarization of these signals is not changing. However, the combiner 152 may be a polarization combiner in that it may combine the two optical signals provided to it at its two inputs but change polarization of one of the input optical signals to a substantially orthogonal polarization. For example, when the TX amplifier output signals 143-1 and 143-2 are the two inputs to the combiner 152, the combiner 152 may generate a combiner output signal 153 that is a combination of the TX amplifier output signal 143-1 switched to the orthogonal polarization by the combiner 152 and the TX amplifier output signal 143-2 with the same polarization as was provided at the input to the combiner 152. In this example, the combiner output signal 153 may include (e.g., be a combination of) modulated portions of the wavelengths λ2, λ4, λ6, λ8, λ10, λ12, λ14, and λ16 with the same polarization as in the optical signal 131-2 (e.g., substantially horizontal polarization) and modulated portions of the wavelengths λ1, λ3, λ5, λ7, λ9, λ11, λ13, and λ15 with an orthogonal polarization to that in the optical signal 131-1 (e.g., substantially vertical polarization). Alternatively, the combiner 152 could generate a combiner output signal 153 that is a combination of the TX amplifier output signal 143-2 switched to the orthogonal polarization by the combiner 152 and the TX amplifier output signal 143-1 with the same polarization as was provided at the input to the combiner 152. In such an example, the combiner output signal 153 may include (e.g., be a combination of) modulated portions of the wavelengths λ1, λ3, λ5, λ7, λ9, λ11, λ13, and λ15 with the same polarization as in the optical signal 131-1 (e.g., substantially horizontal polarization) and modulated portions of the wavelengths λ2, λ4, λ6, λ8, λ10, λ12, λ14, and λ16 with an orthogonal polarization to that in the optical signal 131-2 (e.g., substantially vertical polarization). The combiner output signal 153 may be provided to the optical connector 160 to which a TX fiber 172 may be coupled, so that the combiner output signal 153 may propagate further, out of the optical connector 160, through the TX fiber 172.

In the photonic device 100, splitting the wavelengths λ1 to λN generated by the laser array 110 into odd and even wavelengths that propagate on different busses between the multiplexer 130 and the combiner 152 may allow providing a larger separation between adjacent wavelengths, which may help decrease cross-talk (or electromagnetic interference) between adjacent wavelengths within a given bus. Furthermore, when odd and even wavelengths are modulated on separate busses, cross-modulation may be reduced or eliminated. In some embodiments, the photonic device 100 may be configured so that only a subset of all wavelengths would go through the TX optical amplifier 142 at the same time, e.g., only wavelengths of one bus at a time (e.g., only 8 wavelengths at a time, for the example shown in FIG. 1), which may help reduce the load on the TX optical amplifier 142 and help ensure that the TX optical amplifier 142 operates away from saturation. Combining all of the wavelengths λ1 to λN back into a single bus by the combiner 152 allows using a single TX fiber 172 to support propagation of all of the wavelengths while still decreasing cross-talk between adjacent wavelengths in the TX fiber 172 because adjacent wavelengths have orthogonal polarizations and, therefore, do not interfere with one another. The TX amplifier output signals 143-1 and 143-2 are described herein as being the two inputs to the combiner 152, but analogous descriptions are applicable if the TX optical amplifier 142 was not included in the photonic device 100, in which case the modulator output signals 123-1 and 123-2 would be the two inputs to the combiner 152.

On the RX path of the photonic device 100, the operation may be substantially reversed compared to the TX path. An optical signal comprising modulated odd and even wavelengths of orthogonal polarizations (or, more generally, modulated first and second subsets of wavelengths of orthogonal polarizations) may propagate through the RX fiber 174, enter the optical connector 160, and emerge from the optical connector 160 as a multi-wavelength RX signal 161. In the example shown in FIG. 1, the RX signal 161 may be similar to the combiner output signal 153 in that it may include alternating linear polarizations for adjacent wavelengths of the wavelengths λ1 to λN. The splitter 154 may be a polarization splitter in that it may separate wavelengths of different polarizations of the RX signal 161 into separate busses, rotate one of the polarizations of the RX signal 161 to a substantially orthogonal polarization, and provide the separated multi-wavelength optical signals of substantially orthogonal polarizations at its output as splitter output signals 155-1 and 155-2. The splitter output signal 155-1 may be similar to the TX amplifier output signal 143-1 in that it may include modulated portions of the wavelengths λ1, λ3, λ5, λ7, λ9, λ11, λ13, and λ15 of a given polarization, and the splitter output signal 155-2 may be similar to the TX amplifier output signal 143-2 in that it may include modulated portions of the wavelengths λ2, λ4, λ6, λ8, λ10, λ12, λ14, and λ16 of the same polarization. An RX optical amplifier 144 may then amplify the splitter output signals 155-1 and 155-2 to output their amplified versions as, respectively, an RX amplifier output signal 145-1 and an RX amplifier output signal 145-2 (together referred to as “RX amplifier output signals 145”).

In each signal branch at the outputs of the RX optical amplifier 144 (i.e., in a path for each of the RX amplifier output signals 145), the detector array 180 may include a respective detector arrangement 182 including at least the number of detectors (each denoted as “P” in FIG. 1) that is equal to the number of wavelengths in the corresponding optical signal 145, each of the detectors P configured to de-modulate and detect a portion of the optical signal 145 of one of the wavelengths λ1 to λN to extract data embedded into those optical signals. Individual detector arrangements 182 are labeled in FIG. 1 as a detector arrangement 182-1 in a path of the optical signal 145-1 and a detector arrangement 182-2 in a path of the optical signal 145-2. The number of detectors P within a detector arrangement 182 of a given branch of the detector array 180 may be equal to the number of the wavelengths combined in the optical signal 145 of that branch. Thus, as shown in FIG. 1, the detector arrangement 182-1 includes detectors P corresponding to different odd wavelengths of the wavelengths λ1 to λN (the detectors P individually labeled with a reference numeral following the letter “P” to indicate one of the wavelengths λ1 to λN), i.e., detectors P1, P3, . . . , P13, and P15. Similarly, as shown in FIG. 1, the detector arrangement 182-2 includes detectors P corresponding to different even wavelengths of the wavelengths λ1 to λN, i.e., detectors P2, P4, . . . , P14, and P16.

For a given optical signal 145, each of the detectors P of the detector arrangement 182 in the path of that optical signal 145 is configured to de-modulate and detect a portion corresponding to one of the wavelengths λ1 to λN. For example, for the optical signal 145-1, a detector P1 of the detector arrangement 182-1 is configured to de-modulate and detect a portion corresponding to the wavelength λ1 within the optical signal 145-1, a detector P3 is configured to de-modulate and detect a portion corresponding to the wavelength λ3 within the optical signal 145-1, a detector P5 is configured to de-modulate and detect a portion corresponding to the wavelength λ5 within the optical signal 145-1, and so on. In some embodiments, there may be a one-to-one correspondence between the number of the wavelengths λ1 to λN and the combination of the detectors P of the detector arrangements 182-1 and 182-2.

In some embodiments, the detectors P may be wavelength-selective detectors, which means that a given detector P may receive as an input an optical signal that includes multiple wavelengths, but only apply de-modulation and detection to a portion of the optical signal for which the carrier wavelength is that of the associated one of the wavelengths λ1 to λN. Multiple detectors P of a given detector arrangement 182 in the path of that optical signal 145 may be connected in series (e.g. an output of one detector may be an input to the next detector), similar to the modulators T, described above. The optical signals 145 from the RX optical amplifier 144 are described herein as being the two inputs to the detector array 180, but analogous descriptions are applicable if the RX optical amplifier 144 was not included in the photonic device 100, in which case the splitter output signals 155-1 and 155-2 would be the two inputs to the detector array 180.

Different ways of implementing detectors P are known in the art, all of which being within the scope of the present disclosure. For example, in some embodiments, detectors P of the detector array 180 may be implemented as photodiodes, avalanche photodiodes (APDs), positive-intrinsic-negative (PIN) photodiodes, etc., and may be wavelength-selective detectors. The choice of the type of the detectors P implemented in the detector array 180 may depend on factors such as the modulation format, signal power levels, distance, and system requirements. Different detectors may be suitable for different applications within the broader field of optical communication.

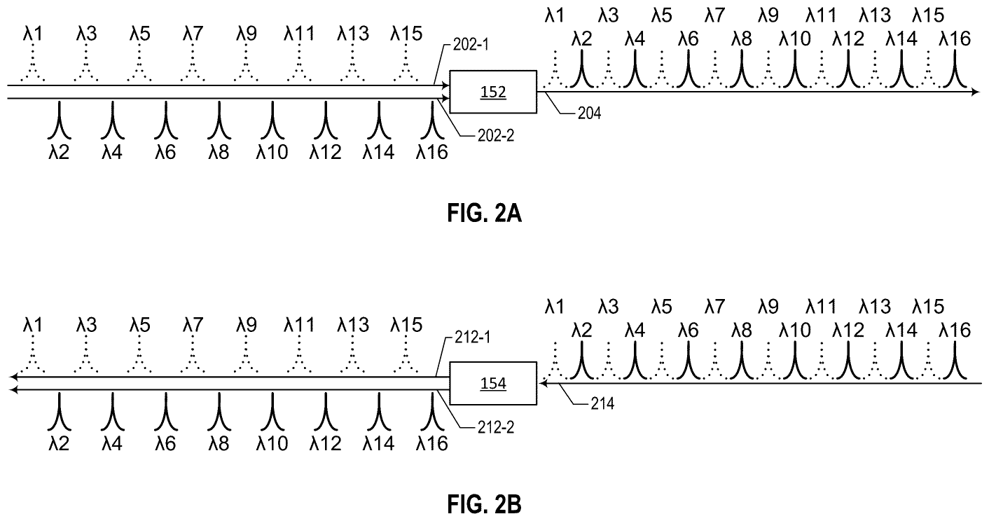

FIGS. 2A-2B illustrate wavelength distribution across two busses as shown in FIG. 1, according to an embodiment. In particular, FIG. 2A illustrates a portion of a TX path, while FIG. 2B illustrates a portion of a RX path of the photonic device 100 of FIG. 1. The wavelengths of the first subset are shown with dotted symbols representing individual central wavelengths, while the wavelengths of the second subset are shown with similar symbols but shown as solid symbols.

As shown in FIG. 2A, for the TX path, the first subset may include odd wavelengths, propagating on a first bus 202-1 coupled to the first input of the combiner 152, and the second subset may include even wavelengths, propagating on a second bus 202-2 coupled to the second input of the combiner 152. As also shown in FIG. 2A, the combiner 152 may then combine the two subsets into a single signal, after rotating polarization of one of the subsets to a substantially orthogonal polarization and provide the combination to a single bus 204 coupled to the output of the combiner 152. For example, the first bus 202-1 coupled to the first input of the combiner 152 may be a waveguide or other optical medium for supporting propagation of the TX amplifier output signal 143-1 or the modulator output signals 123-1, the second bus 202-2 coupled to the second input of the combiner 152 may be a waveguide or other optical medium for supporting propagation of the TX amplifier output signal 143-2 or the modulator output signals 123-2, and the single bus 204 coupled to the output of the combiner 152 may be a waveguide or other optical medium for supporting propagation of the combiner output signal 153.

As shown in FIG. 2B, for the RX path, a combination (e.g., superposition) of the first and second subsets may propagate on a single bus 214 coupled to the input of the splitter 154. One of the subsets of wavelengths propagating on the bus 214 may have a polarization substantially orthogonal to the other subset. As also shown in FIG. 2B, the splitter 154 may split the two subsets into respective signals, rotating polarization of one of the subsets to a substantially orthogonal polarization so that polarizations of the two split signals are substantially the same, and provide the first subset (e.g., odd wavelengths, as shown in FIG. 2B) to a first bus 212-1 coupled to the first output of the splitter 154, while providing the second subset (e.g., even wavelengths, as shown in FIG. 2B) to a second bus 212-2 coupled to the second output of the splitter 154. For example, the first bus 212-1 coupled to the first output of the splitter 154 may be a waveguide or other optical medium for supporting propagation of the splitter output signals 155-1 or the optical signal 145-1, the second bus 212-2 coupled to the second output of the splitter 154 may be a waveguide or other optical medium for supporting propagation of the splitter output signals 155-2 or the optical signal 145-2, and the single bus 214 coupled to the input of the splitter 154 may be a waveguide or other optical medium for supporting propagation of the RX signal 161.

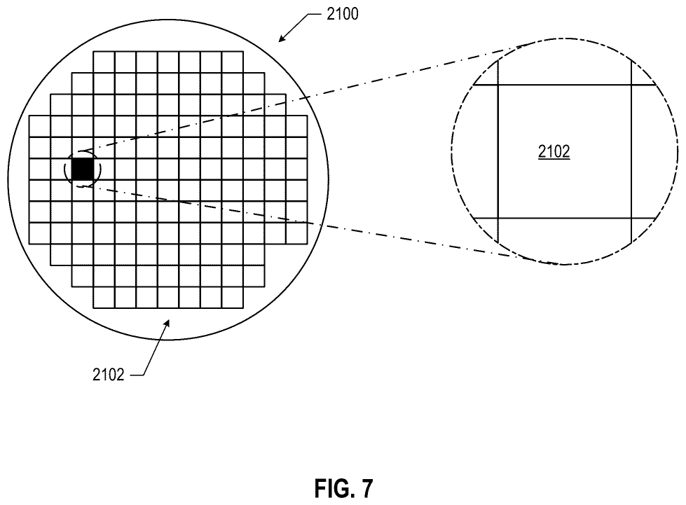

Implementations of the present disclosure may be formed or carried out on any suitable support 102, such as a substrate, a die, a wafer, or a chip. The support 102 may, e.g., be the wafer 2100 of FIG. 7, discussed below, and may be, or be included in, a die, e.g., the singulated die 2102 of FIG. 7, discussed below. The support 102 may be a semiconductor substrate composed of semiconductor material systems including, for example, N-type or P-type materials systems. In one implementation, the semiconductor substrate may be a crystalline substrate formed using a bulk silicon or a silicon-on-insulator (SOI) substructure. In other implementations, the semiconductor substrate may be formed using alternate materials, which may or may not be combined with silicon, that include, but are not limited to, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group III-V materials, group II-VI materials (i.e., materials from groups Il and VI of the periodic system of elements), or group IV materials (i.e., materials from group IV of the periodic system of elements). In some embodiments, the substrate may be non-crystalline. In some embodiments, the support 102 may be a printed circuit board (PCB) substrate, a package substrate, an interposer, a wafer, or a die. In some embodiments, the support 102 may be, or may include, a glass core. As used herein, the term “glass core” refers to a structure (e.g., a portion of a glass layer) of any glass material such as quartz, silica, fused silica, silicate glass (e.g., borosilicate, aluminosilicate, alumino-borosilicate), soda-lime glass, soda-lime silica, borofloat glass, lead borate glass, photosensitive glass, non-photosensitive glass, or ceramic glass. In particular, the glass core may refer to bulk glass or a solid volume of glass, as opposed to, e.g., materials that may include particles of glass, such as glass fiber reinforced polymers. Such glass materials are typically non-crystalline, often transparent, amorphous solids. In some embodiments, a glass core may be an amorphous solid glass layer. In some embodiments, a glass core may include silicon and oxygen, as well as any one or more of aluminum, boron, magnesium, calcium, barium, tin, sodium, potassium, strontium, phosphorus, zirconium, lithium, titanium, and zinc. In some embodiments, a glass core may include a material, e.g., any of the materials described above, with a weight percentage of silicon being at least about 0.5%, e.g., between about 0.5% and 50%, between about 1% and 48%, or at least about 23%. For example, if a glass core is fused silica, the weight percentage of silicon may be about 47%. In some embodiments, a glass core may include at least 23% silicon and at least 26% oxygen by weight, and, in some further embodiments, such a glass core may further include at least 5% aluminum by weight. In some embodiments, a glass core may include any of the materials described above and may further include one or more additives such as aluminum and oxygen (e.g., Al₂O₃), boron and oxygen (e.g., B₂O₃), magnesium and oxygen (e.g., MgO), calcium and oxygen (e.g., CaO), strontium and oxygen (e.g., SrO), barium and oxygen (e.g., BaO), tin and oxygen (e.g., SnO₂), sodium and oxygen (e.g., Na₂O), potassium and oxygen (e.g., K₂O), phosphorous and oxygen (e.g., P₂O₃), zirconium and oxygen (e.g., ZrO₂), lithium and oxygen (e.g., Li₂O), titanium (e.g., Ti), and zinc (Zn). Although a few examples of materials from which the support 102 may be formed are described here, any material that may serve as a foundation upon which photonic devices with polarization-based wavelength combining as described herein may be built falls within the spirit and scope of the present disclosure.

In some embodiments, any two or more of the modulator array 120, the multiplexer 130, the TX optical amplifier 142, the combiner 152, the splitter 154, the RX optical amplifier 144, and the detector array 180 may be implemented on the same support 102. In some embodiments, the optical connector 160 may be a separate component that may be attached to the support 102 (in other words, the optical connector 160 may be detachable from the support 102). In other embodiments, the optical connector 160 may be implemented on the support 102. Various manners for implementing optical connectors for coupling photonic devices, e.g., PICs to fibers leading to other devices, are known in the art, all of which being within the scope of the present disclosure for implementing the optical connector 160. For example, in some embodiments, the optical connector 160 may be implemented as a ferrule with openings for the TX fiber 172 and for the RX fiber 174 (but, typically, an optical connector 160 would include openings for a plurality of TX fibers and openings for a plurality of RX fibers, e.g., as shown in FIG. 6A).

Typically lasers use direct bandgap semiconductor materials such as gallium arsenide (GaAs), indium phosphide (InP), gallium nitride (GaN), or other III-V semiconductors (i.e., semiconductors that are based on elements of group III and group V of the periodic system of elements) for light emission. Compared to indirect bandgap semiconductor materials such as silicon (Si), direct bandgap semiconductors are more fit for emitting light efficiently and coherently. However, semiconductor materials that may not be the most optimal for light generation may be preferable for light transmission and manipulation, with Si being the most prominent example of such a material. For example, Si may be used to fabricate waveguides, gratings, wavelength combiners, or other components of PICs. In some embodiments, one or more of the modulator array 120, the multiplexer 130, the TX optical amplifier 142, the combiner 152, the splitter 154, the RX optical amplifier 144, and the detector array 180 may be implemented as Si components, where, as used herein, the term “Si components” refers to components of any materials other than III-V materials, with Si being one non-limiting example of such materials. In some embodiments, the lasers 112 may be implemented as integrated lasers. A laser or a laser array may be described as “integrated” if components of a laser or a laser array responsible for emitting light (e.g., III-V components) are implemented on a single support (e.g., on the support 102) as components responsible for transmitting and/or manipulating light (e.g., any of the modulator array 120, the multiplexer 130, the TX optical amplifier 142, the combiner 152, the splitter 154, the RX optical amplifier 144, and the detector array 180). In some implementations, an entire optical transmitter (e.g., all components of the TX path, described herein) may be implemented on a single support (e.g., on the support 102) with an integrated laser array of the lasers 112, which may eliminate the need for expensive and lossy coupling between the laser array 110 and a separate transmitter chip. In some embodiments, the optical receiver (e.g., all components of the RX path, described herein) may be implemented on the same support 102 as the optical transmitter and the integrated laser array. In other embodiments, one or more of the modulator array 120, the multiplexer 130, the TX optical amplifier 142, the combiner 152, the splitter 154, the RX optical amplifier 144, and the detector array 180 may be implemented on a different support than the support 102 with the lasers 112.

The photonic device 100 may be particularly advantageous if used as a part of a dense WDM (DWDM) system but is not limited to DWDM systems. The arrangement of the laser array 110, the modulator array 120, the multiplexer 130, the TX optical amplifier 142, the combiner 152, the splitter 154, the RX optical amplifier 144, and the detector array 180 of the photonic devices 100 as shown in FIG. 1 is not the only arrangement in which polarization-based wavelength combining as described herein may be implemented, but merely provides one example of such a photonic device. FIG. 3, FIG. 5, and FIGS. 6A-6C illustrate other example embodiments of the photonic device 100. For the sake of brevity, all of the descriptions provided for the photonic device 100 shown in FIG. 1 are not repeated for the photonic devices 100 shown in FIG. 3, FIG. 5, and FIGS. 6A-6C, but only the differences are described.

FIG. 3 is a schematic illustration of a photonic device 100 that is analogous to that shown in FIG. 1, except that the split of the wavelengths λ1 to λN into first and second subsets is different. In particular, FIG. 3 illustrates that the modulator arrangement 122-1 may include modulators T1 to T8, while the modulator arrangement 122-2 may include modulators T9 to T16, and that, similarly, the detector arrangement 182-1 may include detectors P1 to P8, while the detector arrangement 182-2 may include detectors P9 to P16. This means that, in the embodiment of FIG. 3, the first subset may be a multi-wavelength signal including a combination of a set of a lower band of wavelengths of the sequence of wavelengths λ1 to λN (e.g., a multi-wavelength signal including wavelengths λ1, λ2, λ3, λ4, λ5, λ6, λ7, and λ8), while the second subset may be a multi-wavelength signal including a combination of a set of a higher band of wavelengths of the sequence of wavelengths λ1 to λN (e.g., a multi-wavelength signal including wavelengths λ9, λ10, λ11, λ12, λ13, λ14, λ15, and λ16). Splitting the wavelengths λ1 to λN generated by the laser array 110 into lower band and higher band wavelengths that propagate on different busses between the multiplexer 130 and the combiner 152 may allow reducing the total bandwidth required of the TX optical amplifier 142 because two optical amplifiers with smaller bandwidths may be used to amplify lower band and higher band wavelengths, e.g., as illustrated in FIG. 6B, which may help decrease the overall cost and complexity of the photonic device 100. Similar to the photonic device 100 of FIG. 1, it may also allow reducing the load on the TX optical amplifier 142 because only a subset of all wavelengths would go through the TX optical amplifier 142 at the same time (e.g., only 8 wavelengths at the same time, for the example shown in FIG. 3), which may help ensure that the TX optical amplifier 142 operates away from saturation. Combining all of the wavelengths λ1 to λN back into a single bus by the combiner 152 allows using a single TX fiber 172 to support propagation of all of the wavelengths.

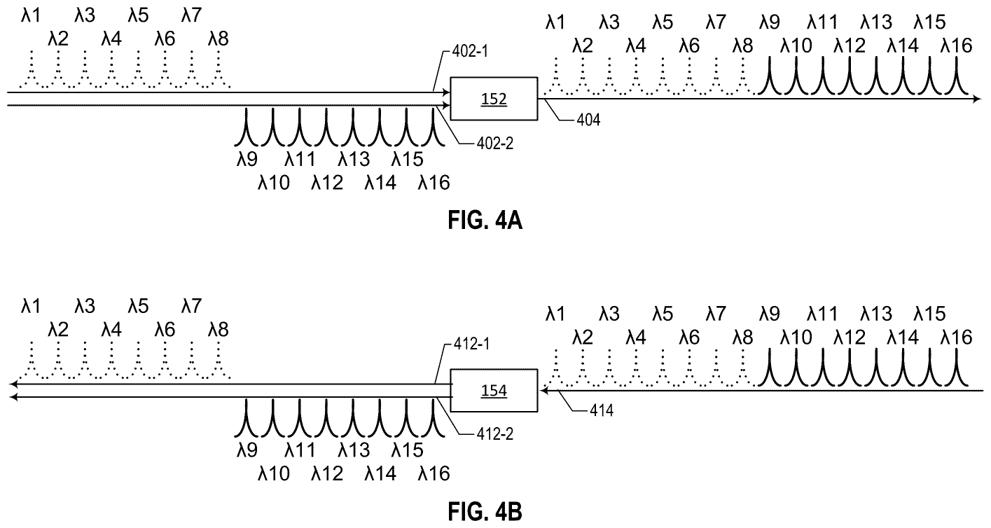

FIGS. 4A-4B illustrate wavelength distribution across two busses as shown in FIG. 3, according to an embodiment. In particular, FIG. 4A illustrates a portion of a TX path, while FIG. 4B illustrates a portion of a RX path of the photonic device 100 of FIG. 3. Similar to FIGS. 2A-2B, in FIGS. 4A-4B the wavelengths of the first subset are shown with dotted symbols representing individual central wavelengths, while the wavelengths of the second subset are shown with similar symbols but shown as solid symbols.

As shown in FIG. 4A, for the TX path, the first subset may include a lower band of wavelengths, propagating on a first bus 402-1 coupled to the first input of the combiner 152, and the second subset may include a higher band of wavelengths, propagating on a second bus 402-2 coupled to the second input of the combiner 152. As also shown in FIG. 4A, the combiner 152 may then combine the two subsets into a single signal, after rotating polarization of one of the subsets to a substantially orthogonal polarization and provide the combination to a single bus 404 coupled to the output of the combiner 152. For example, the first bus 402-1 coupled to the first input of the combiner 152 may be a waveguide or other optical medium for supporting propagation of the TX amplifier output signal 143-1 or the modulator output signals 123-1, the second bus 402-2 coupled to the second input of the combiner 152 may be a waveguide or other optical medium for supporting propagation of the TX amplifier output signal 143-2 or the modulator output signals 123-2, and the single bus 404 coupled to the output of the combiner 152 may be a waveguide or other optical medium for supporting propagation of the combiner output signal 153.

As shown in FIG. 4B, for the RX path, a combination (e.g., superposition) of the first and second subsets may propagate on a single bus 414 coupled to the input of the splitter 154. One of the subsets of wavelengths propagating on the bus 414 may have a polarization substantially orthogonal to the other subset. As also shown in FIG. 4B, the splitter 154 may split the two subsets into respective signals, rotating polarization of one of the subsets to a substantially orthogonal polarization so that polarizations of the two split signals are substantially the same, and provide the first subset (e.g., a lower band of wavelengths, as shown in FIG. 4B) to a first bus 412-1 coupled to the first output of the splitter 154, while providing the second subset (e.g., a higher band of wavelengths, as shown in FIG. 4B) to a second bus 412-2 coupled to the second output of the splitter 154. For example, the first bus 412-1 coupled to the first output of the splitter 154 may be a waveguide or other optical medium for supporting propagation of the splitter output signals 155-1 or the optical signal 145-1, the second bus 412-2 coupled to the second output of the splitter 154 may be a waveguide or other optical medium for supporting propagation of the splitter output signals 155-2 or the optical signal 145-2, and the single bus 414 coupled to the input of the splitter 154 may be a waveguide or other optical medium for supporting propagation of the RX signal 161

FIG. 5 is a schematic illustration of a photonic device 100 that is analogous to that shown in FIG. 1 or in FIG. 3, except for the differences within the laser array 110 and within the multiplexer 130. In particular, FIG. 5 illustrates that instead of having single-wavelength lasers 112, as shown in FIG. 1 or FIG. 3, the photonic device 100 may include one or more multi-wavelength lasers 512. As shown in FIG. 5, the laser array 110 may include four lasers 512, each of which may be a multi-wavelength laser that can output light at four different wavelengths, so that, in total, the four lasers 512 also output optical signals of N different wavelengths, λ1 to λN, similar to the lasers 112. The lasers 512 are individually shown in FIG. 5 as a laser 512-1, a laser 512-2, a laser 512-3, and a laser 512-4. In such an embodiment, the laser 512-1 may output light of wavelengths λ1, λ3, λ5, and λ7, provided as a multi-wavelength optical signal at the output of the laser 512-1; the laser 512-2 may output light of wavelengths λ9, λ11, λ13, and λ15, provided as a multi-wavelength optical signal at the output of the laser 512-2; the laser 512-3 may output light of wavelengths λ2, λ4, λ6, and λ8, provided as a multi-wavelength optical signal at the output of the laser 512-3; and the laser 512-4 may output light of wavelengths λ10, λ12, λ14, and λ16, provided as a multi-wavelength optical signal at the output of the laser 512-4. Thus, for the example of FIG. 5, N is equal to 16, as for FIG. 1. As shown in FIG. 5, the multi-wavelength lasers generating odd wavelengths, i.e., the lasers 512-1 and 512-2, may be grouped together in that they may provide their outputs to a WDM multiplexer 532-1. Similarly, the multi-wavelength lasers generating even wavelengths, i.e., the lasers 512-3 and 512-4, may be grouped together in that they may provide their outputs to a WDM multiplexer 532-2. The outputs of the WDM multiplexer 532-1 and the WDM multiplexer 532-2 may then be provided to a swizzle network 534. The WDM multiplexer 532-1 may be configured to receive the odd wavelengths of the wavelengths λ1 to λN output by the laser array 110 and combine them into a single first multi-wavelength signal provided to the swizzle network 534. Similarly, the WDM multiplexer 532-2 may be configured to receive the even wavelengths of the wavelengths λ1 to λN output by the laser array 110 and combine them into a single second multi-wavelength signal provided to the swizzle network 534. The swizzle network 534 may then provide optical signals 131-1 and 131-2 according to any embodiments described herein based on the inputs received from the WDM multiplexers 532-1 and 532-2. Arrangement of the laser array 110 and the multiplexer 130 as shown in FIG. 5 may be advantageous in terms of a smaller or less complicated swizzle network 534, which may result in lower loss. The details of the modulator arrangements 122 and the detector arrangements 182 are not shown in FIG. 5 and their respective boxes are shaded, indicating that the modulator arrangements 122 and the detector arrangements 182 of the photonic device 100 of FIG. 5 may be implemented according to any embodiments described herein.

FIGS. 6A-6C illustrate further example embodiments of the photonic device 100. Similar to FIG. 5, the details of some of the components of the photonic device 100 are not shown in FIGS. 6A-6C and their respective boxed are shaded, indicating that these components of the photonic devices 100 of FIGS. 6A-6C may be implemented according to any embodiments described herein. For example, in FIG. 6A, details of the modulator arrangements 122 and the detector arrangements 182 are not shown and their respective boxes are shaded, indicating that the modulator arrangements 122 and the detector arrangements 182 of the photonic device 100 of FIG. 6A may be implemented according to any embodiments described herein. Furthermore, details of the laser array 110 and the multiplexer 130 are not shown in FIG. 6A and their respective boxes are shaded, indicating that the laser array 110 and the multiplexer 130 of the photonic device 100 of FIG. 6A may be implemented according to any embodiments described herein, as long as the laser array 110 can generate and provide to the multiplexer 130 light of N different wavelengths, λ1 to λN (either using single-wavelength lasers, e.g., the lasers 112 described herein, or using multi-wavelength lasers, e.g., the lasers 512 described herein), and the multiplexer 130 can generate optical signals 131 as described herein.

FIG. 6A is a schematic illustration of a photonic device 100 that is analogous to that shown in any of the other drawings, except for the differences in the number of TX and RX paths. In particular, FIG. 6A illustrates that a photonic device 100 according to any embodiments described herein may include multiple TX paths and multiple RX paths, shown in FIG. 6A as K TX paths and K RX paths, where K is any integer greater than 1. Respective TX fibers 172 may be coupled to different ones of the K TX paths, via the corresponding K openings for the TX fibers 172 in the optical connector 160, as shown in FIG. 6A with a TX fiber 172-1 being coupled to the first TX path, and with a TX fiber 172-K being coupled to the Kth TX path (thus, there may be a one-to-one correspondence between the TX fibers 172 and TX paths). Similarly, respective RX fibers 174 may be coupled to different ones of the K RX paths, via the corresponding K openings for the RX fibers 174 in the optical connector 160, as shown in FIG. 6A with a RX fiber 174-1 being coupled to the first RX path, and with a RX fiber 174-K being coupled to the Kth RX path (thus, there may be a one-to-one correspondence between the RX fibers 174 and RX paths). If each TX path includes two optical signals 131-1 and 131-2 as described herein, and the multiplexer 130 is a multiplexer providing M outputs, then K=M/2 or, conversely, M=2K. In some embodiments, output power of the optical signals 131-1 and 131-2 in each of K TX paths may be 1/Kths of the output power of the N different wavelengths provided to the multiplexer 130 from the laser array 110. The photonic device 100 as shown in FIG. 6A may be advantageous because it may support higher data rates.

FIG. 6B is a schematic illustration of a photonic device 100 that is analogous to that shown in any of the other drawings, except for the differences in the number of TX optical amplifiers 142 and/or RX optical amplifiers 144. In particular, FIG. 6B illustrates that a photonic device 100 according to any embodiments described herein may include respective (i.e., different) TX optical amplifiers 142 in the two paths of the optical signals 131, shown as a TX optical amplifier 142-1 in the path of the optical signal 131-1 and as a TX optical amplifier 142-2 in the path of the optical signal 131-2. Similarly, FIG. 6B illustrates that a photonic device 100 according to any embodiments described herein may include respective (i.e., different) RX optical amplifiers 144 in the two paths of the splitter output signals 155-1 and 155-2, shown as a RX optical amplifier 144-1 in the path of the splitter output signal 155-1 and as a RX optical amplifier 144-2 in the path of the splitter output signal 155-2. In other embodiments, a photonic device 100 may include respective TX optical amplifiers 142-1 and 142-2 in the paths of the optical signals 131-1 and 131-2 (e.g., as shown in FIG. 6B) but a single RX optical amplifier 144 in the paths of both of the splitter output signals 155-1 and 155-2 (e.g., as shown in FIG. 1). In still other embodiments, a photonic device 100 may include a single TX optical amplifier 142 in the paths of both of the optical signals 131-1 and 131-2 (e.g., as shown in FIG. 1), but respective RX optical amplifiers 144-1 and 144-2 in the paths of the splitter output signals 155-1 and 155-2 (e.g., as shown in FIG. 6B). The photonic device 100 as described with reference to FIG. 6B may be advantageous because it may reduce requirements on the individual TX optical amplifiers 142 and/or RX optical amplifiers 144, e.g., enable using optical amplifiers with a smaller bandwidth and/or with a lower saturation point, which may reduce complexity and cost of the photonic device.

FIG. 6C is a schematic illustration of a photonic device 100 that is analogous to that shown in other drawings, except that the order of the RX optical amplifier 144 and the splitter 154 is reversed. Thus, as shown in FIG. 6C, first, the RX optical amplifier 144 may apply amplification to the RX signal 161 and provide at an output a optical signal 145 that is an amplified version of the RX signal 161, and only after that may the splitter 154 split the optical signal 145 into the splitter output signals 155-1 and 155-2. The photonic device 100 as described with reference to FIG. 6C may be advantageous because instead of amplifying two separate signals, the RX optical amplifier 144 shown in FIG. 6C only amplifies one signal.

Various arrangements of the photonic devices 100 as illustrated in FIGS. 1-5 and FIGS. 6A-6C do not represent an exhaustive set of photonic devices in which polarization-based wavelength combining as described herein may be used, but merely provide some illustrative examples. In particular, the number and positions of various elements shown in FIGS. 1-5 and FIGS. 6A-6C is purely illustrative and, in various other embodiments, other numbers of these elements, provided in other locations relative to one another may be used in accordance with the general architecture considerations described herein. For example, although not specifically shown in the present drawings in a single combination, in some embodiments, K TX paths and K RX paths described with reference to FIG. 6A may be implemented for any of the photonic devices 100 described with reference to FIGS. 6B-6C. In another example, when a photonic device 100 includes multiple TX paths, e.g., as shown in FIG. 6A, the multiplexer 130 may be configured to apply one manner of splitting the wavelengths λ1 to λN into first and second subsets for one of the TX paths (e.g., to split the wavelengths λ1 to λN into first and second subsets in a manner illustrated in FIGS. 2A-2B), but apply another way to split the wavelengths λ1 to λN into first and second subsets for another one of the TX paths (e.g., to split the wavelengths λ1 to λN into first and second subsets in a manner illustrated in FIGS. 4A-4B). In yet another example, although also not specifically shown in the present drawings, in some embodiments, any of the photonic devices 100 described herein may include additional lasers within the laser array 110 to provide redundancy in case one or more of the lasers fail, as known in the art.

Arrangements with one or more photonic devices 100 according to any embodiments disclosed herein may be included in any suitable electronic device. FIGS. 7-9 illustrate various examples of devices and components that may include one or more photonic devices 100 according to any embodiments disclosed herein, or any combination of such embodiments.

FIG. 7 illustrates top views of a wafer 2100 and dies 2102 that may be included in one or more photonic devices with polarization-based wavelength combining, according to an embodiment, e.g., in one or more photonic devices 100 according to any of the embodiments of FIGS. 1-5 and FIGS. 6A-6C or any combination of such embodiments. In some embodiments, the dies 2102 may be included in an IC package, in accordance with any of the embodiments disclosed herein. For example, any of the dies 2102 may serve as any of the dies 2256 in an IC package 2200 shown in FIG. 8. The wafer 2100 may be composed of semiconductor material and may include one or more dies 2102 having IC structures formed on a surface of the wafer 2100. Each of the dies 2102 may be a repeating unit of a semiconductor product that includes any suitable IC (e.g., ICs including one or more IC devices implementing any portion of any of the photonic devices 100 as described herein). After the fabrication of the semiconductor product is complete (e.g., after manufacture of one or more photonic devices 100 according to any of the embodiments of FIGS. 1-5 and FIGS. 6A-6C or any combination of such embodiments), the wafer 2100 may undergo a singulation process in which each of the dies 2102 is separated from one another to provide discrete “chips” of the semiconductor product. In particular, devices that include one or more laser arrays 110 and/or photonic devices 100 as described herein may take the form of the wafer 2100 (e.g., not singulated) or the form of the die 2102 (e.g., singulated). The die 2102 may include supporting circuitry to route electrical and/or optical signals to various components, e.g., to various lasers of the laser arrays 110, transistors, capacitors, resistors, as well as any other IC components. In some embodiments, the wafer 2100 or the die 2102 may implement or include a laser array (e.g., any embodiments of the laser array 110 as described herein), a photonic device with a laser array (e.g., any embodiments of the photonic device 100 with the laser array 110), or any other suitable circuit element. Multiple ones of these devices may be combined on a single die 2102. For example, multiple laser arrays 110 as described herein or multiple photonics devices 100 as described herein may be formed on a same die 2102.

FIG. 8 is a side, cross-sectional view of an example microelectronic package 2200 that may include one or more photonic devices with polarization-based wavelength combining, e.g., one or more photonic devices 100 according to any of the embodiments of FIGS. 1-5 and FIGS. 6A-6C or any combination of such embodiments. In some embodiments, the microelectronic package 2200 may be a system-in-package (SiP).

The package substrate 2252 may be formed of a dielectric material (e.g., a ceramic, a buildup film, an epoxy film having filler particles therein, etc.), and may have conductive pathways 2262 extending through the dielectric material between the face 2272 and the face 2274, or between different locations on the face 2272, and/or between different locations on the face 2274.

The package substrate 2252 may include conductive contacts 2263 that are coupled to conductive pathways 2262 through the package substrate 2252, allowing circuitry within the dies 2256 and/or the interposer 2257 to electrically couple to various ones of the conductive contacts 2264 (or to other devices included in the package substrate 2252, not shown).

The microelectronic package 2200 may include an interposer 2257 coupled to the package substrate 2252 via conductive contacts 2261 of the interposer 2257, first-level interconnects 2265, and the conductive contacts 2263 of the package substrate 2252. The first-level interconnects 2265 illustrated in FIG. 8 are solder bumps, but any suitable first-level interconnects 2265 may be used. In some embodiments, no interposer 2257 may be included in the microelectronic package 2200; instead, the dies 2256 may be coupled directly to the conductive contacts 2263 at the face 2272 by first-level interconnects 2265.

The microelectronic package 2200 may include one or more dies 2256 coupled to the interposer 2257 via conductive contacts 2254 of the dies 2256, first-level interconnects 2258, and conductive contacts 2260 of the interposer 2257. The conductive contacts 2260 may be coupled to conductive pathways (not shown) through the interposer 2257, allowing circuitry within the dies 2256 to electrically couple to various ones of the conductive contacts 2261 (or to other devices included in the interposer 2257, not shown). The first-level interconnects 2258 illustrated in FIG. 8 are solder bumps, but any suitable first-level interconnects 2258 may be used. As used herein, a “conductive contact” may refer to a portion of electrically conductive material (e.g., metal) serving as an interface between different components; conductive contacts may be recessed in, flush with, or extending away from a surface of a component, and may take any suitable form (e.g., a conductive pad or socket).

In some embodiments, an underfill material 2266 may be disposed between the package substrate 2252 and the interposer 2257 around the first-level interconnects 2265, and a mold compound 2268 may be disposed around the dies 2256 and the interposer 2257 and in contact with the package substrate 2252. In some embodiments, the underfill material 2266 may be the same as the mold compound 2268. Example materials that may be used for the underfill material 2266 and the mold compound 2268 are epoxy mold materials, as suitable. Second-level interconnects 2270 may be coupled to the conductive contacts 2264. The second-level interconnects 2270 illustrated in FIG. 8 are solder balls (e.g., for a ball grid array arrangement), but any suitable second-level interconnects 22770 may be used (e.g., pins in a pin grid array arrangement or lands in a land grid array arrangement). The second-level interconnects 2270 may be used to couple the microelectronic package 2200 to another component, such as a circuit board (e.g., a motherboard), an interposer, or another IC package, as known in the art.

The dies 2256 may take the form of any of the embodiments of the die 2102 discussed herein (e.g., may include any of the embodiments of the IC devices with laser arrays 110 and/or photonic devices 100 as described herein). In embodiments in which the microelectronic package 2200 includes multiple dies 2256, the microelectronic package 2200 may be referred to as a multi-chip package (MCP). The dies 2256 may include circuitry to perform any desired functionality. In some embodiments, any of the dies 2256 may include one or more laser arrays 110 and/or photonic devices 100 as described herein; in some embodiments, at least some of the dies 2256 may not include any laser arrays 110 or photonic devices 100 as described herein.

The microelectronic package 2200 illustrated in FIG. 8 may be a flip chip package, although other package architectures may be used. For example, the microelectronic package 2200 may be a ball grid array (BGA) package, such as an embedded wafer-level ball grid array (eWLB) package. In another example, the microelectronic package 2200 may be a wafer-level chip scale package (WLCSP) or a panel fan-out (FO) package. Although two dies 2256 are illustrated in the microelectronic package 2200 of FIG. 8, an IC package 2200 may include any desired number of the dies 2256. An IC package 2200 may include additional passive components, such as surface-mount resistors, capacitors, and inductors disposed on the first face 2272 or the second face 2274 of the package substrate 2252, or on either face of the interposer 2257. More generally, an IC package 2200 may include any other active or passive components known in the art.

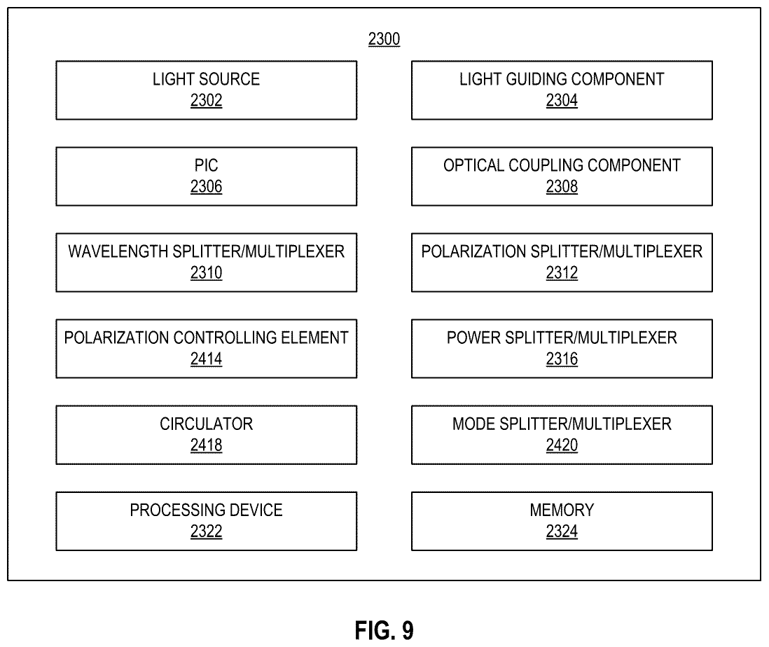

FIG. 9 is a block diagram of an example photonic device 2300 that may include one or more components in which one or more photonic devices with polarization-based wavelength combining, e.g., one or more photonic devices 100 according to any of the embodiments of FIGS. 1-5 and FIGS. 6A-6C or any combination of such embodiments, may be implemented. For example, any suitable ones of the components of the photonic device 2300 may include a die (e.g., the die 2102 of FIG. 7) having one or more microelectronic packages (e.g., microelectronic packages 2200 of FIG. 8). More generally, any suitable ones of the components of the photonic device 2300 may include one or more of laser arrays 110 and/or photonic devices 100 as described herein.

A number of components are illustrated in FIG. 9 as included in the photonic device 2300, but any one or more of these components may be omitted or duplicated, as suitable for the application. In some embodiments, some or all of the components included in the photonic device 2300 may be attached to one or more motherboards or any suitable support structure. In some embodiments, some or all of these components are fabricated onto a single system-on-chip (SoC) die. Additionally, in various embodiments, the photonic device 2300 may not include one or more of the components illustrated in FIG. 9, but the photonic device 2300 may include interface circuitry for coupling to the one or more components. For example, the photonic device 2300 may not include a processing device 2322, but may include processing device interface circuitry (e.g., a connector and driver circuitry) to which a processing device 2322 may be coupled. In another example, the photonic device 2300 may not include a memory 2324, but may include memory interface circuitry (e.g., connectors and supporting circuitry) to which a memory 2324 may be coupled. In yet another example, the photonic device 2300 may not include a circulator 2318, but may include circulator interface circuitry (e.g., connectors) to which a circulator 2318 may be coupled

In some embodiments, the photonic device 2300 may include at least one light source 2302. In some embodiments, the light source 2302 may be, or may include, any of the laser arrays 110 described herein. In general, the light source 2302 may include any suitable device for providing the necessary optical signals for various applications of the photonic device 2300, ranging from communication to sensing and imaging. The light source 2302 may be designed to emit light in a controlled and efficient manner to meet the specific requirements of the photonic device 2300. In some embodiment, the light source 2302 may be a coherent and monochromatic light source such as a laser, to produce light of a well-defined wavelength, low divergence, and high brightness. Examples of lasers that may be included in the light source 2302 include semiconductor lasers, such as edge-emitting lasers and vertical-cavity surface-emitting lasers (VCSELs). Such lasers may be particularly advantageous when the photonic device 2300 is used in applications like optical communication, sensing, and laser-based treatments in medical devices. In some embodiment, the light source 2302 may be a non-coherent light source such as a light-emitting diode (LED) that emits light when an electric current is applied. LEDs may be simpler and more cost-effective than lasers, making them suitable for applications where high coherence is not required. Using an LED as the light source 2302 may be particularly advantageous when the photonic device 2300 is used in applications like displays, optical sensors, and short-distance communication systems. In further embodiments, the light source 2302 may include one or more of a superluminescent diode (SLD), a quantum dot, a rare-earth-doped fiber/waveguide, a plasma source (e.g., plasmonics and microplasma devices), a microcavity resonators, or a nonlinear optical device (e.g., a photonic device that uses nonlinear optical processes, such as frequency doubling or parametric amplification, to generate new wavelengths).

In some embodiments, the photonic device 2300 may include at least one light guiding component 2304, such as a waveguide, to manipulate and control the propagation of light. The light guiding component 2304 may include any suitable waveguide structures designed to confine and guide light along a specified path, allowing it to travel from one point to another with minimal loss and dispersion. Examples of waveguides that may be used as the light guiding component 2304 include planar waveguides, optical fibers, photonic crystal waveguides, and rib waveguides. In some embodiments, the light guiding component 2304 may include a material with a higher refractive index, known as the “core,” surrounded by a material with a lower refractive index, known as the “cladding.” The refractive index contrast between the core and cladding helps guide light within the core by using total internal reflection. Light is trapped within the core due to its reflection at the core-cladding interface. The light guiding component 2304 may support various modes of light propagation, such as single-mode or multimode.

In some embodiments, the photonic device 2300 may include at least one PIC 2306. A PIC 2306 may be a miniaturized and integrated optical device that incorporates photonic components, such as optical modulators, photodetectors, and waveguides, onto a single substrate. In some embodiments, the PIC 2306 may include one or more optical modulators for encoding data onto an optical signal, e.g., onto light generated by the light source 2302. An optical modulator of the PIC 2306 may change certain properties of an optical signal, such as its amplitude, frequency, or phase, in order to encode information onto the signal or to perform various signal processing functions. Examples of optical modulators that may be implemented in the PIC 2306 include electro-optic modulators, MZI modulators, or microring modulators. In some embodiments, the PIC 2306 may include one or more photodetectors for detecting and measuring the intensity of light or optical radiation across various wavelengths by converting incident light/photons into an electrical signal. Examples of photodetectors that may be implemented in the PIC 2306 include photodiodes, avalanche photodiodes, phototransistors, PIN diodes, CMOS image sensors, photomultiplier tubes, or quantum photodetectors. In some embodiments, the PIC 2306 may include one or more waveguides, e.g., any of the waveguides described with reference to the light guiding component 2304.

In some embodiments, the photonic device 2300 may include at least one optical coupling component 2308. The optical coupling component 2308 may include any suitable structures designed to facilitate efficient transfer of light between different optical devices, e.g., between the light source 2302 and the light guiding component 2304, between the light source 2302 and the PIC 2306, between the light guiding component 2304 and the PIC 2306, or between the light guiding component 2304 or the PIC 2306 and a further transmission line such as a fiber (not shown in FIG. 9) that may be coupled to the PIC 2306. Examples of optical coupling elements that may be used to implement the optical coupling component 2308 include fiber couplers (e.g., fused fiber couplers or tapered fiber couplers), waveguide couplers, grating couplers, lens couplers, microlens couplers, prism couplers, fiber array couplers, or ball lens couplers.

In some embodiments, the photonic device 2300 may include at least one wavelength splitter/multiplexer 2310, to combine or split multiple optical signals that are carried at different wavelengths. This may be particular advantageous if the photonic device 2300 is used in an optical communication system such as a WDM system or a DWDM system, where multiple data channels are transmitted simultaneously over a single optical fiber using different wavelengths of light. In various embodiments, the wavelength splitter/multiplexer 2310 may include a wavelength division multiplexer, a wavelength division demultiplexer, a passive optical add/drop multiplexer, an arrayed waveguide grating, a fused fiber couplers, and interleavers, or an optical filter based device.

In some embodiments, the photonic device 2300 may include at least one polarization splitter/multiplexer 2312, to combine or split multiple optical signals depending on their polarization. Similarly, in some embodiments, the photonic device 2300 may include at least one polarization controlling component 2314, to control polarization of light generated and manipulated in the photonic device 2300. In various embodiments, a polarization splitter/multiplexer 2312 and a polarization controlling component 2314 may include any suitable structure to enable the manipulation and management of polarized light signals, such as birefringent materials, waveguide structures, or specialized coatings that interact differently with different polarization states.

In some embodiments, the photonic device 2300 may include at least one general power splitter/multiplexer 2316, to combine or split multiple optical signals that in a manner that is not dependent on wavelength or polarization. For example, in some embodiments a power splitter/multiplexer 2316 may be used to tap off a small amount of optical power for purposes or power monitoring in the photonic device 2300. Examples of devices that may be used as a power splitter/multiplexer 2316 include directional couplers and multimode interference couplers.

In some embodiments, the photonic device 2300 may include at least one circulator 2318, also referred to as a “directional splitter.” The circulator 2318 may include any suitable device configured to direct light signals to travel in a specific, one-way circular path through its ports. In some embodiments, the circulator 2318 may include magneto-optic materials or other techniques that create a Faraday rotation effect, where the polarization of light is rotated as it passes through the circulator 2318.

In some embodiments, the photonic device 2300 may include at least one mode splitter/multiplexer 2320, to combine or split multiple optical signals based on their guided modes. Examples of devices that may be used as a mode splitter/multiplexer 2320 include directional couplers, multimode interference couplers, tapered waveguide couplers, photonic lanterns, or photonic crystal splitters.

In some embodiments, the photonic device 2300 may include a processing device 2322 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 2322 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. In some embodiments, the processing device 2322 may include circuitry to control operation of other components of the photonic device 2300, e.g., to control operation of the PIC 2306.

In some embodiments, the photonic device 2300 may include a memory 2324, which may itself include one or more memory devices such as volatile memory (e.g., DRAM), nonvolatile memory (e.g., read-only memory (ROM)), flash memory, solid state memory, and/or a hard drive. In some embodiments, the memory 2404 may include memory that shares a die with the processing device 2322. This memory may be used as cache memory and may include embedded DRAM (eDRAM) or spin transfer torque magnetic random-access memory (MRAM). In some embodiments, the memory 2324 may store instructions or data for the processing device 2322 to control operation of other components of the photonic device 2300, e.g., to control operation of the PIC 2306.

The following paragraphs provide examples of various ones of the embodiments disclosed herein.

Example 1 provides a photonic device that includes multiplexer circuitry controllable to output a first optical signal and a second optical signal based on optical signals of N distinct wavelengths provided to the multiplexer circuitry, where N is an integer greater than 2, the first optical signal includes a combination (e.g., a superposition) of a first subset of the N wavelengths, the second optical signal includes a combination (e.g., a superposition) of a second subset of the N wavelengths, and the first subset and the second subset are complementary subsets of the N wavelengths; a combiner; a first bus coupled between the multiplexer circuitry and the combiner, to support propagation of the first optical signal from the multiplexer circuitry to the combiner; and a second bus coupled between the multiplexer circuitry and the combiner, to support propagation of the second optical signal from the multiplexer circuitry to the combiner, where the combiner is controllable to change a polarization of the first optical signal from a first polarization to a second polarization, different from the first polarization, and after changing the polarization of the first optical signal, combine the first optical signal and the second optical signal to provide a combiner output signal, where the second optical signal within the combiner output signal has the first polarization.

Example 2 provides the photonic device according to example 1, further including a first set of one or more modulators controllable to apply modulation to the first optical signal before the first optical signal reaches the combiner; and a second set of one or more modulators controllable to apply modulation to the second optical signal before the second optical signal reaches the combiner.

Example 3 provides the photonic device according to example 2, where: an individual modulator of the first set is controllable to apply modulation to one wavelength of the first subset of the N wavelengths (e.g., each modulator of the first set is controllable to apply modulation to a respective (i.e., different) one of first subset of the N wavelengths) and pass other wavelengths of the first subset without modulation, and an individual modulator of the second set is controllable to apply modulation to one wavelength of the second subset of the N wavelengths (e.g., each modulator of the second set is controllable to apply modulation to a respective (i.e., different) one of second subset of the N wavelengths) and pass other wavelengths of the second subset without modulation.

Example 4 provides the photonic device according to examples 2 or 3, where the first set of one or more modulators includes at least same number of modulators as a number of wavelengths in the first subset of the N wavelengths, and where the second set of one or more modulators includes at least same number of modulators as a number of wavelengths in the second subset of the N wavelengths.

Example 5 provides the photonic device according to any one of examples 2-4, where the one or more modulators of the first set and/or the one or more modulators of the second set include one or more ring modulators, e.g., one or more wavelength-selective ring modulators.

Example 6 provides the photonic device according to any one of examples 2-5, where: the first set of one or more modulators is coupled to the first bus, between the multiplexer circuitry and the combiner, and the second set of one or more modulators is coupled to the second bus, between the multiplexer circuitry and the combiner.

Example 7 provides the photonic device according to any one of the preceding examples, further including optical amplifier circuitry controllable to amplify the first optical signal before the first optical signal reaches the combiner and/or to amplify the second optical signal before the second optical signal reaches the combiner.

Example 8 provides the photonic device according to example 7, where the optical amplifier circuitry includes first optical amplifier to amplify the first optical signal before the first optical signal reaches the combiner, and second optical amplifier to amplify the second optical signal before the second optical signal reaches the combiner.

Example 9 provides the photonic device according to any one of the preceding examples, further including a plurality of lasers controllable to provide the optical signals of N distinct wavelengths.

Example 10 provides the photonic device according to example 9, where at least one laser of the plurality of lasers (or each of the plurality of lasers) is a single-wavelength laser.

Example 11 provides the photonic device according to examples 9 or 10, where at least one laser of the plurality of lasers (or each of the plurality of lasers) is a multi-wavelength laser.

Example 12 provides the photonic device according to any one of examples 9-11, where at least one laser of the plurality of lasers (or each of the plurality of lasers) is a DFB laser.

Example 13 provides the photonic device according to any one of examples 9-12, where at least one laser of the plurality of lasers (or each of the plurality of lasers) is a DBR laser.

Example 14 provides the photonic device according to any one of the preceding examples, where the first polarization is substantially orthogonal to the second polarization.

Example 15 provides the photonic device according to any one of the preceding examples, where one of the first polarization and the second polarization is a substantially horizontal polarization and another one is a substantially vertical polarization.

Example 16 provides the photonic device according to any one of the preceding examples, where the first polarization and the second polarization are linear polarizations.

Example 17 provides the photonic device according to any one of examples 1-16, where, when the N wavelengths are arranged in a sequence that is either an ascending sequence or a descending sequence, one of the first subset and the second subset includes odd wavelengths of the sequence and another one of the first subset and the second subset includes even wavelengths of the sequence.

Example 18 provides the photonic device according to any one of examples 1-16, where one of the first subset and the second subset includes wavelengths that are lower than lowest wavelength of another one of the first subset and the second subset.

Example 19 provides the photonic device according to any one of the preceding examples, further including a substrate (which may include a die, a wafer, or a chip, and may be referred to, more generally, as a “support”), where the first bus, the second bus, and the combiner are on the substrate.

Example 20 provides the photonic device according to example 19, where the substrate further includes the multiplexer circuitry.

Example 21 provides a photonic device that includes combiner circuitry having a first input, a second input, and an output; a first bus coupled to the first input of the combiner circuitry; a second bus coupled to the second input of the combiner circuitry; and a third bus coupled to the output of the combiner circuitry, where the combiner circuitry is configured to: receive a first optical signal from the first bus, receive a second optical signal from the second bus, where the first optical signal and the second optical signal have a first polarization, change polarization of the second optical signal to a second polarization, different from the first polarization, provide a combiner output signal by combining the first optical signal of the first polarization and the second optical signal of the second polarization, and provide the combiner output signal to the third bus.

Example 22 provides the photonic device according to example 21, where: the first optical signal is a multi-wavelength signal including a first subset of N distinct wavelengths, the second optical signal is a multi-wavelength signal including a second subset of the N wavelengths, and the first subset and the second subset are disjoint subsets.

Example 23 provides the photonic device according to example 22, where the first subset and the second subset are complementary subsets of the N wavelengths.

Example 24 provides a microelectronic assembly that includes a die, and a further component coupled to the die, where the die includes a photonic device according to any one of the preceding examples. For example, the die may include a first optical waveguide to support propagation of a first multi-wavelength optical signal, a second optical waveguide to support propagation of a second multi-wavelength optical signal, a third optical waveguide to support propagation of a third multi-wavelength optical signal, and a combiner to receive the first multi-wavelength optical signal from the first optical waveguide, receive the second multi-wavelength optical signal from the second optical waveguide, and provide to the third optical waveguide the third multi-wavelength optical signal, wherein the third multi-wavelength optical signal is a combination of the first multi-wavelength optical signal having a first polarization and the second multi-wavelength optical signal having a second polarization, different from the first polarization.

Example 25 provides the microelectronic assembly according to example 24, where the further component is one of a package substrate, a circuit board, an interposer, or another die.

Example 26 provides the microelectronic assembly according to examples 24 or 25, further including one or more optical interconnects to couple the further component to the die.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A photonic device, comprising:
multiplexer circuitry controllable to output a first optical signal and a second optical signal based on optical signals of N wavelengths, wherein N is an integer greater than 2, the first optical signal includes a first subset of the N wavelengths, the second optical signal includes a second subset of the N wavelengths, and the first subset and the second subset are complementary subsets of the N wavelengths;
a combiner;
a first bus coupled between the multiplexer circuitry and the combiner, to support propagation of the first optical signal from the multiplexer circuitry to the combiner; and
a second bus coupled between the multiplexer circuitry and the combiner, to support propagation of the second optical signal from the multiplexer circuitry to the combiner,
wherein the combiner is controllable to:
change a polarization of the first optical signal from a first polarization to a second polarization, different from the first polarization, and
after changing the polarization of the first optical signal, combine the first optical signal and the second optical signal to provide a combiner output signal, wherein the second optical signal within the combiner output signal has the first polarization.

2. The photonic device according to claim 1, further comprising:
a first set of one or more modulators controllable to apply modulation to the first optical signal before the first optical signal reaches the combiner; and
a second set of one or more modulators controllable to apply modulation to the second optical signal before the second optical signal reaches the combiner.

3. The photonic device according to claim 2, wherein:
an individual modulator of the first set is controllable to apply modulation to one wavelength of the first subset of the N wavelengths, and
an individual modulator of the second set is controllable to apply modulation to one wavelength of the second subset of the N wavelengths.

4. The photonic device according to claim 2, wherein the first set of one or more modulators includes at least same number of modulators as a number of wavelengths in the first subset of the N wavelengths, and wherein the second set of one or more modulators includes at least same number of modulators as a number of wavelengths in the second subset of the N wavelengths.

5. The photonic device according to claim 2, wherein the one or more modulators of the first set or the one or more modulators of the second set include one or more ring modulators.

6. The photonic device according to claim 2, wherein:
the first set of one or more modulators is coupled to the first bus, between the multiplexer circuitry and the combiner, and
the second set of one or more modulators is coupled to the second bus, between the multiplexer circuitry and the combiner.

7. The photonic device according to claim 1, further comprising:
optical amplifier circuitry controllable to amplify the first optical signal before the first optical signal reaches the combiner or to amplify the second optical signal before the second optical signal reaches the combiner.

8. The photonic device according to claim 7, wherein the optical amplifier circuitry includes:
first optical amplifier to amplify the first optical signal before the first optical signal reaches the combiner, and
second optical amplifier to amplify the second optical signal before the second optical signal reaches the combiner.

9. The photonic device according to claim 1, further comprising:
a plurality of lasers controllable to provide the optical signals of N wavelengths, wherein at least one laser of the plurality of lasers is a distributed feedback laser or a distributed Bragg reflector laser.

10. The photonic device according to claim 1, wherein the first polarization is substantially orthogonal to the second polarization.

11. The photonic device according to claim 1, wherein one of the first polarization and the second polarization is a substantially horizontal polarization and another one is a substantially vertical polarization.

12. The photonic device according to claim 1, wherein the first polarization and the second polarization are linear polarizations.

13. The photonic device according to claim 1, wherein, when the N wavelengths are arranged in a sequence that is either an ascending sequence or a descending sequence, one of the first subset and the second subset includes odd wavelengths of the sequence and another one of the first subset and the second subset includes even wavelengths of the sequence.

14. The photonic device according to claim 1, wherein one of the first subset and the second subset includes wavelengths that are lower than lowest wavelength of another one of the first subset and the second subset.

15. The photonic device according to claim 1, further comprising:
a substrate,
wherein the first bus, the second bus, and the combiner are on the substrate.

16. The photonic device according to claim 15, wherein the substrate further includes the multiplexer circuitry.

17. A photonic device, comprising:
combiner circuitry having a first input, a second input, and an output;
a first bus coupled to the first input of the combiner circuitry;
a second bus coupled to the second input of the combiner circuitry; and
a third bus coupled to the output of the combiner circuitry,
wherein the combiner circuitry is to:
receive a first optical signal from the first bus,
receive a second optical signal from the second bus, wherein the first optical signal and the second optical signal have a first polarization,
change polarization of the second optical signal to a second polarization, different from the first polarization,
provide a combiner output signal by combining the first optical signal of the first polarization and the second optical signal of the second polarization, and
provide the combiner output signal to the third bus.

18. The photonic device according to claim 17, wherein:
the first optical signal is a multi-wavelength signal comprising a first subset of N wavelengths,
the second optical signal is a multi-wavelength signal comprising a second subset of the N wavelengths, and
the first subset and the second subset are disjoint subsets.

19. A microelectronic assembly, comprising:
a die; and
a further component coupled to the die,
wherein the die includes:
a first optical waveguide to support propagation of a first multi-wavelength optical signal,
a second optical waveguide to support propagation of a second multi-wavelength optical signal,
a third optical waveguide to support propagation of a third multi-wavelength optical signal, and a combiner to:
receive the first multi-wavelength optical signal from the first optical waveguide,
receive the second multi-wavelength optical signal from the second optical waveguide, and
provide to the third optical waveguide the third multi-wavelength optical signal, wherein the third multi-wavelength optical signal is a combination of the first multi-wavelength optical signal having a first polarization and the second multi-wavelength optical signal having a second polarization, different from the first polarization.

20. The microelectronic assembly according to claim 19, wherein the further component is one of a package substrate, a circuit board, an interposer, or another die.
